(19) United States
(12) Patent Application Publication
(10) Pub. No.: US 2023/0360383 A1
(43) Pub. Date: Nov. 9, 2023

(54) IMAGE PROCESSING APPARATUS AND OPERATION METHOD THEREOF

(71) Applicant: SAMSUNG ELECTRONICS CO., LTD., Suwon-si (KR)

(72) Inventors: Hyunseung LEE, Suwon-si (KR); Youngsu MOON, Suwon-si (KR)

(73) Assignee: SAMSUNG ELECTRONICS CO., LTD., Suwon-si (KR)

(21) Appl. No.: 18/143,326

(22) Filed: May 4, 2023

Related U.S. Application Data
(63) Continuation of application No. PCT/KR2023/004946, filed on Apr. 12, 2023.

(30) Foreign Application Priority Data
May 6, 2022 (KR) 10-2022-0056250
Aug. 11, 2022 (KR) 10-2022-0100733

(51) Int. Cl. G06V 10/82; G06V 10/72

(52) U.S. Cl. CPC G06V 10/82; G06V 10/72

(57) ABSTRACT

An image processing method including obtaining a meta model based on a quality of an input image, training the meta model by using a training data set corresponding to the input image, and obtaining a quality-processed output image from the input image based on the trained meta model.

### CROSS-REFERENCE TO RELATED APPLICATIONS

This application is a continuation application of International Application No. PCT/KR2023/004946, filed on Apr. 12, 2023, in the Korean Intellectual Property Office, which is based on and claims priority to Korean Patent Application No. 10-2022-0056250, filed on May 6, 2022, and Korean Patent Application No. 10-2022-0100733, filed on Aug. 11, 2022, the disclosures of each of which being incorporated by reference herein in their entireties.

### BACKGROUND

### 1. Field

The disclosure relates to an image processing apparatus and an operation method thereof, and more particularly, to an image processing apparatus and an operation method for outputting a resulting image by performing image-quality processing on a low-quality image.

### 2. Description of Related Art

Along with the development of deep learning technology, various learning-based upscaling methods are being developed. A learning-based upscaling method exhibits excellent performance when quality characteristics of a training image are similar to those of an input image to be actually processed, but leads to significant degradation in image quality when characteristics of an image to be processed differ from input image quality assumed during training.

To address this problem, on-device learning research has been conducted to process and adapt an artificial intelligence (AI) model to input data.

### SUMMARY

In accordance with an aspect of the disclosure, an image processing apparatus may include a memory storing one or more instructions and one or more processors configured to access the memory and execute the one or more instructions stored in the memory to obtain a meta model based on a quality of an input image, train the meta model by using a training data set corresponding to the input image, and obtain a quality-processed output image from the input image, based on the trained meta model.

In accordance with another aspect of the disclosure, an image processing method performed by an image processing apparatus may include obtaining a meta model based on a quality of an input image, training the meta model by using a training data set corresponding to the input image, and obtaining a quality-processed output image from the input image based on the trained meta model.

In accordance with yet another aspect of the disclosure, a computer-readable recording medium recorded thereon a program which, when executed by one or more processors, causes the one or more processors to at least obtain a meta model based on a quality of an input image; train the meta model by using a training data set corresponding to the input image; and obtain a quality-processed output image from the input image based on the trained meta model.

Additional aspects will be set forth in part in the description which follows and, in part, will be apparent from the description, or may be learned by practice of the presented embodiments.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram for describing an example in which an image processing apparatus outputs a quality-processed image according to some embodiments;

FIG. 2 is an internal block diagram of an image processing apparatus according to some embodiments;

FIG. 3 is an internal block diagram of a processor of FIG. 2, according to some embodiments;

FIG. 4 is a diagram for describing a neural network used to determine the quality of an input image, according to some embodiments;

FIG. 5 is a graph illustrating the quality of an input image according to some embodiments;

FIG. 6 is a diagram for describing a model trainer of FIG. 3 according to some embodiments;

FIG. 7 is a diagram for describing an example in which a training database (DB) generator of FIG. 6 obtains an image in a similar category to an input image, according to some embodiments;

FIG. 8 is a diagram for describing an example in which the training DB generator of FIG. 6 performs image quality processing on an image in a similar category to an input image, according to some embodiments;

FIG. 9 is a diagram for describing a method of applying degradation occurring during a compression process to a training image, according to some embodiments;

FIG. 10 is a diagram for describing an example in which a meta model is obtained using reference models, according to some embodiments;

FIG. 11 is a diagram for describing an example of the model trainer of FIG. 3 according to some embodiments;

FIG. 12 is an internal block diagram of an image processing apparatus according to some embodiments;

FIG. 13 is a flowchart of a method of performing image quality processing on an input image, according to some embodiments;

FIG. 14 is a flowchart of a process of obtaining a meta model based on the quality of an input image, according to some embodiments; and

FIG. 15 is a flowchart of a process of obtaining a training data set corresponding to an input image, according to some embodiments.

### DETAILED DESCRIPTION

Throughout the disclosure, the expression “at least one of a, b or c” includes within its scope only a, only b, only c, both a and b, both a and c, both b and c, all of a, b, and c, or variations thereof.

Various embodiments will be described more fully hereinafter with reference to the accompanying drawings so that they may be easily implemented by one of ordinary skill in the art. However, the disclosure may be implemented in different forms and should not be construed as being limited to an embodiment set forth herein.

The terminology used in the disclosure is described as a general term currently used in the art based on functions described in the disclosure, but the terminology may mean various other terms according to an intention of a technician engaged in the art, precedent cases, advent of new technologies, etc. Thus, the terms used herein should be defined not by simple appellations thereof but based on the meaning of the terms together with the overall description of the disclosure.

In addition, the terms used herein are only used to describe a particular embodiment, and are not intended to limit the disclosure.

Throughout the specification, it will be understood that when a part is referred to as being “connected” or “coupled” to another part, it may be “directly connected” to or “electrically coupled” to the other part with one or more intervening elements therebetween.

The use of the terms “the” and similar referents used in the specification, especially in the following claims, are to be construed to cover both the singular and the plural. Furthermore, operations of a method according to the disclosure described herein may be performed in any suitable order unless clearly specified herein. The disclosure is not limited to the described order of the operations.

Expressions such as “in some embodiments” or “in an embodiment” described in various parts of this specification do not necessarily refer to the same embodiment(s).

Some embodiments may be described in terms of functional block components and various processing operations. Some or all of such functional blocks may be implemented by any number of hardware and/or software components that execute specific functions. For example, functional blocks may be implemented by one or more microprocessors or by circuit components for performing certain functions. Furthermore, functional blocks may be implemented with various programming or scripting languages. The functional blocks may be implemented using various algorithms executed by one or more processors. Furthermore, the disclosure may employ techniques of the related art for electronics configuration, signal processing, and/or data processing. The terms such as “mechanism”, “element”, “means”, and “construction” may be used in a broad sense and are not limited to mechanical or physical components.

Furthermore, connecting lines or connectors shown in various figures are intended to represent exemplary functional relationships and/or physical or logical couplings between components in the figures. In an actual device, connections between components may be represented by many alternative or additional functional relationships, physical connections, or logical connections.

As used herein, the term “unit” or “module” indicates a unit for processing at least one function or operation and may be implemented using hardware or software or a combination of hardware and software.

In addition, in the specification, the term “user” refers to a person who uses an image processing apparatus and may include a consumer, an evaluator, a viewer, an administrator, or an installation engineer. Also, in the specification, a “manufacturer” may refer to a manufacturer that manufactures an image processing apparatus and/or components included in the image processing apparatus.

In an on-device learning research field, a technique for Zero-Shot Super-Resolution using Deep Internal Learning has been proposed.

The Zero-Shot Super Resolution (ZSSR) technique is a technique for constructing a database (DB) using an input image itself adaptively according to degradation characteristics of the input image and increasing a size of an image by using a model trained using the DB. Because ZSSR creates a new DB adaptively for each input image from scratch and trains a model by using the new DB, the ZSSR has drawbacks in that the ZSSR technique suffers from high computational training complexity and it is difficult for the ZSSR to be applied to a video with an inconsistent image quality.

In order to improve on these problems, another technique called Fast Adaptation to Super-Resolution Networks via Meta-Learning has been proposed. The Fast Adaptation technique presents a technique for training an initial meta model from an external DB and finding a model suitable for features of an input image via transfer learning in order to reduce the computational complexity of training in ZSSR. However, because the Fast Adaptation technique uses only a single meta model, the single meta model has a limitation in performance that features of various input images are not all included the single meta model, and in an environment using a low-capacity network such as in an edge device, such a limitation of the meta model becomes a factor that limits the performance of on-device learning.

Because the ZSSR and Fast Adaptation techniques both exploit an input image to construct a training DB for training, the ZSSR and Fast Adaptation techniques exhibit image quality improvement performance when the input image is a still image, such as, for example, a building with repetitive edge features or periodic textures. However, in the real world, in addition to images assumed in the existing methods, there are many images that have deteriorated during capturing, transmission, and compression processes, and these images have lossy high-frequency components that are a clue for restoration of quality, and finding repeated components in the images is often difficult. Therefore, there is a limit to constructing a training DB with only an input image, which leads to performance degradation.

In addition, because the existing methods are developed to improve the quality of still images, it is difficult to apply the methods to videos. A model independently trained for each image may have a variation in restoration performance due to differences in the degree of convergence of training and characteristics of a training DB. For this reason, when an independent model is applied for each frame, sharpness of an image also changes each time, which may cause a flicker distortion that is temporal non-uniformity in image quality.

Some embodiments provide an image processing apparatus and an operation method thereof for obtaining a meta model suitable for features of an input image by interpolating a plurality of pre-trained reference models.

Some embodiments provide an image processing apparatus and an operation method thereof for training a meta model based on training data obtained using images having similar content characteristics to an input image.

Some embodiments provide an image processing apparatus and an operation method thereof for processing an image quality of a current frame by using a model trained based on the current frame together with a model used for image restoration in a previous frame.

In accordance with an aspect of one or more embodiments, an image processing apparatus may include a memory storing one or more instructions and one or more processors configured to execute the one or more instructions stored in the memory to obtain a meta model based on a quality of an input image, train the meta model by using a training data set corresponding to the input image, and obtain a quality-processed output image from the input image, based on the trained meta model.

In some embodiments, the one or more processors may be further configured to execute the one or more instructions to obtain an averaged quality value for the input image obtained at a first time point by considering both a quality value of the input image at the first time point and a quality value of an input image obtained at a past time point before the first time point, and obtain a meta model corresponding to the averaged quality value.

In some embodiments, the one or more processors may be further configured to execute the one or more instructions to obtain the meta model by using a plurality of reference models, and the plurality of reference models may each be an image quality processing model pre-trained with training images having a different quality value.

In some embodiments, the different quality value may be determined based on a distribution of quality values of training images.

In some embodiments, the one or more processors may be further configured to execute the one or more instructions to search for one or more reference models among the plurality of reference models by comparing each of quality values corresponding to the plurality of reference models with a quality value of the input image and obtain the meta model by using one or more reference models found among the one or more reference models.

In some embodiments, the one or more processors may be further configured to execute the one or more instructions to, based on the found reference model being a plurality of reference models, assign weights respectively to the found plurality of reference models and obtain a meta model by performing a weighted sum operation on the plurality of reference models assigned the weights, and each of the weights may be determined according to a difference between a quality value corresponding to a reference model and the quality value of the input image.

In some embodiments, the one or more processors may be further configured to execute the one or more instructions to obtain the quality of the input image, and the quality of the input image may include at least one of a compression quality, a blur quality, a resolution, or noise for the input image.

In some embodiments, the one or more processors may be further configured to execute the one or more instructions to identify a category of the input image, obtain an image belonging to the identified category, obtain an image with degraded quality by processing the image belonging to the identified category to have a quality corresponding to the quality of the input image, and obtain the training data set including the image belonging to the identified category and the image with degraded quality.

In some embodiments, the one or more processors may be further configured to execute the one or more instructions to train the meta model so that a difference between the image belonging to the identified category and an image output from the meta model by inputting the image with degraded quality to the meta model is minimized.

In some embodiments, the one or more processors may be further configured to execute the one or more instructions to obtain the image with degraded quality by performing at least one of compression degradation, blurring degradation, resolution adjustment, or noise addition on the image belonging to the identified category.

In some embodiments, the one or more processors may be further configured to execute the one or more instructions to perform compression degradation on the image belonging to the identified category by encoding and decoding the image belonging to the identified category.

In some embodiments, the one or more processors may be further configured to execute the one or more instructions to obtain the meta model each time at least one of a frame, a scene including a plurality of frames, or a content type changes, and train the obtained meta model.

In some embodiments, the one or more processors may be further configured to execute the one or more instructions to obtain a first time point exponential moving average model by considering both a meta model trained at a first time point and a meta model trained at a past time point before the first time point, and obtain the quality-processed output image by applying the first time point exponential moving average model to the input image.

An image processing method performed by an image processing apparatus, according to some embodiments, may include obtaining a meta model based on a quality of an input image, training the meta model by using a training data set corresponding to the input image, and obtaining a quality-processed output image from the input image based on the trained meta model.

A computer-readable recording medium according to some embodiments may have recorded thereon a program for implementing an image processing method including obtaining a meta model based on a quality of an input image, training the meta model by using a training data set corresponding to the input image, and obtaining a quality-processed output image from the input image, based on the trained meta model.

An image processing apparatus and operation method thereof according to some embodiments are capable of obtaining a meta model suitable for features of an input image by interpolating a plurality of pre-trained reference models.

An image processing apparatus and operation method thereof according to some embodiments are capable of training a meta model based on training data obtained using images having similar content characteristics to an input image.

An image processing apparatus and operation method thereof according to some embodiments of the disclosure are capable of processing an image quality of a current frame by using a model trained based on the current frame together with a model used for image restoration in a previous frame.

Hereinafter, various embodiments will be described in detail with reference to the accompanying drawings.

FIG. 1 is a diagram for describing an example in which an image processing apparatus 100 outputs a quality-processed image according to some embodiments.

Referring to FIG. 1, the image processing apparatus 100 may be an electronic apparatus capable of processing and outputting an image. In some embodiments, the image processing apparatus 100 may be implemented as various types of electronic apparatuses including displays.

The image processing apparatus 100 may be implemented in a fixed or mobile form, and may be a digital television (TV) capable of receiving digital broadcasts. The image processing apparatus 100 may include at least one of a desktop computer, a smartphone, a tablet personal computer (PC), a mobile phone, a video phone, an e-book reader, and a laptop PC, a netbook computer, a digital camera, a personal multimedia assistant (PDA), a portable able multimedia player (PMP), a camcorder, a navigation device, a wearable device, a smart watch, a home network system, a security system, or a medical device.

The image processing apparatus 100 may be implemented not only as a flat display device but also as a curved display device with a screen having a curvature or a flexible display device with an adjustable curvature. An output resolution of the image processing apparatus 100 may include, for example, High Definition (HD), Full HD, Ultra HD, or resolution higher than the Ultra HD.

The image processing apparatus 100 may output a video. A video may include a plurality of frames. Videos may include items for various movies, dramas, etc., available via video on demand (VOD) services or TV programs provided by content providers. A content provider may refer to a terrestrial broadcasting station, a cable broadcasting station, an over-the-top (OTT) service provider, or an Internet Protocol (IP) TV service provider that provides various types of content including a video to consumers.

After a video is captured, compressed, and transmitted, the video is then restored and output by the image processing apparatus 100. Distortion of an image occurs when information is lost due to limitations in physical characteristics and a limited bandwidth of a device used to capture a video. The quality of the distorted video is degraded.

In some embodiments, the image processing apparatus 100 may receive a video provided by a content provider and assess the quality of the received video. Because the image processing apparatus 100 performs image quality estimation using only the received distorted image, the image processing apparatus 100 may assess the quality of an image by using a no-reference quality assessment method. The image processing apparatus 100 may assess the quality of a video and/or an image by using an image quality assessment (IQA) technique and/or a video quality assessment (VQA) technique.

In some embodiments, the image processing apparatus 100 may evaluate an input image 110 to obtain quality of the input image 110. Image quality may refer to the quality of an image or the degree of degradation in the image. In some embodiments, the image processing apparatus 100 may evaluate the input image 110 and obtain at least one of a compression quality, a blur quality, a resolution, or a noise for the input image 110.

In some embodiments, the image processing apparatus 100 may be an electronic apparatus in which an artificial intelligence (AI) engine is combined with an edge device that outputs an image to a user.

AI technology may include machine learning (deep learning) and element technologies using the machine learning. AI technology may be implemented using algorithms. Here, an algorithm or a set of algorithms for implementing AI technology is referred to as a neural network. The neural network may receive input data, perform computations for analysis and classification, and output resulting data.

In some embodiments, the image processing apparatus 100 may process quality of an image using on-device AI technology. In some embodiments, the image processing apparatus 100 may process the quality of an image more quickly because the image processing apparatus 100 collects, calculates, and processes information on its own without going through a cloud server.

In some embodiments, the image processing apparatus 100 may include an on-device AI operating unit that processes data using on-device AI technology.

In some embodiments, the on-device AI operating unit may also be referred to as an on-device learning system. The on-device AI operating unit may obtain a model to process the quality of the input image 110, and apply transfer learning to the model by using training data suitable for characteristics of the input image 110 to generate a meta model adaptive to the input image 110. A meta model may refer to an approximate model to replace a real model.

In some embodiments, the on-device AI operating unit may obtain a meta model by using a plurality of reference models. In some embodiments, a reference model may be a pre-trained image quality processing model. In some embodiments, the plurality of reference models may be each pre-trained with training images having a quality value corresponding to each of the plurality of reference models. A quality value corresponding to a model may be a quality value of training images used to train the model.

The plurality of reference models may be image quality processing models that are trained using training images having different qualities.

In some embodiments, the on-device AI operating unit may search for one or more reference models among a plurality of reference models by comparing a quality value of the input image 110 with each of quality values respectively corresponding to the plurality of reference models, and selecting one or more reference models as found reference models whose quality value corresponds to the quality value of the input image. In some embodiments, one or more reference models whose quality value is equal to the quality value of the input image 110 may be selected as one or more found reference models. In some embodiments, one or more reference models whose quality value is within a threshold range of the quality value of the input image 110 may be selected as one or more found reference models.

In some embodiments, when one reference model is found, the on-device AI operating unit may obtain the found reference model as a meta model.

In some embodiments, when a plurality of reference models are found, the on-device AI operating unit may obtain a meta model by interpolating the plurality of found reference models.

In some embodiments, obtaining a meta model by interpolating a plurality of found reference models may mean generating a meta model by interpolating parameter values of the plurality of found reference models.

In some embodiments, the on-device AI operating unit may stabilize the quality of an image by taking into account a case where quality obtained for each image is not accurate or the quality of the image changes rapidly.

In some embodiments, the on-device AI operating unit may obtain a meta model corresponding to an averaged quality value for the input image 110 instead of obtaining a meta model by using a quality value of the input image 110, and perform image-quality processing using the obtained meta model after the obtained meta model is trained, so that the quality of images may be further uniformly processed.

In some embodiments, the on-device AI operating unit may train the meta model adaptively according to the input image 110. To achieve this adaptive training, the on-device AI operating unit may obtain training data suitable for the input image 110 and train the meta model using the obtained training data.

In some embodiments, to obtain training data suitable for the input image 110, the on-device AI operating unit may analyze the input image 110 to obtain features of the input image 110 and analyze the features of the input image 110 to identify a category of the input image 110.

In some embodiments, the on-device AI operating unit may process an image belonging to the identified category to have a quality corresponding to the quality of the input image 110 to thereby obtain an image with degraded quality.

In some embodiments, the on-device AI operating unit may obtain an image with degraded quality by performing at least one of compression degradation, blurring degradation, resolution adjustment, or noise addition on an image belonging to the identified category.

In some embodiments, the on-device AI operating unit may perform compression degradation on an image belonging to the identified category by encoding and decoding the image belonging to the identified category.

In some embodiments, the on-device AI operating unit may obtain an image belonging to the identified category and an image with degraded quality as a training data set.

In some embodiments, the on-device AI operating unit may train a meta model by using a training data set obtained based on the input image 110.

In some embodiments, the on-device AI operating unit may train a meta model by updating parameter values of the meta model to minimize a difference between an image belonging to the identified category and an image output from the meta model by inputting an image with degraded quality to the meta model.

In some embodiments, the on-device AI operating unit may obtain and train a meta model periodically or at random intervals.

In some embodiments, the on-device AI operating unit may stabilize a meta model by taking into account a case where a rapid change in image quality occurs when different meta models are applied to each image.

In some embodiments, the image processing apparatus 100 may load a meta model refined or updated by the on-device AI operating unit and perform image quality processing by applying the refined or updated meta model to the input image 110 to thereby obtain a quality-processed output image 120. In some embodiments, because the trained meta model is generated considering a category of the input image 110 and the quality of the input image 110, the meta model may more accurately process the quality of the input image 110.

In this way, according to some embodiments, by using the on-device AI operating unit, the image processing apparatus 100 may obtain a meta model suitable for features of the input image 110 by interpolating a plurality of pre-trained reference models, based on the quality of the input image 110

Furthermore, the image processing apparatus 100 may obtain a training data set by using images having content characteristics similar to characteristics of the input image 110 and train a meta model using the obtained training data set.

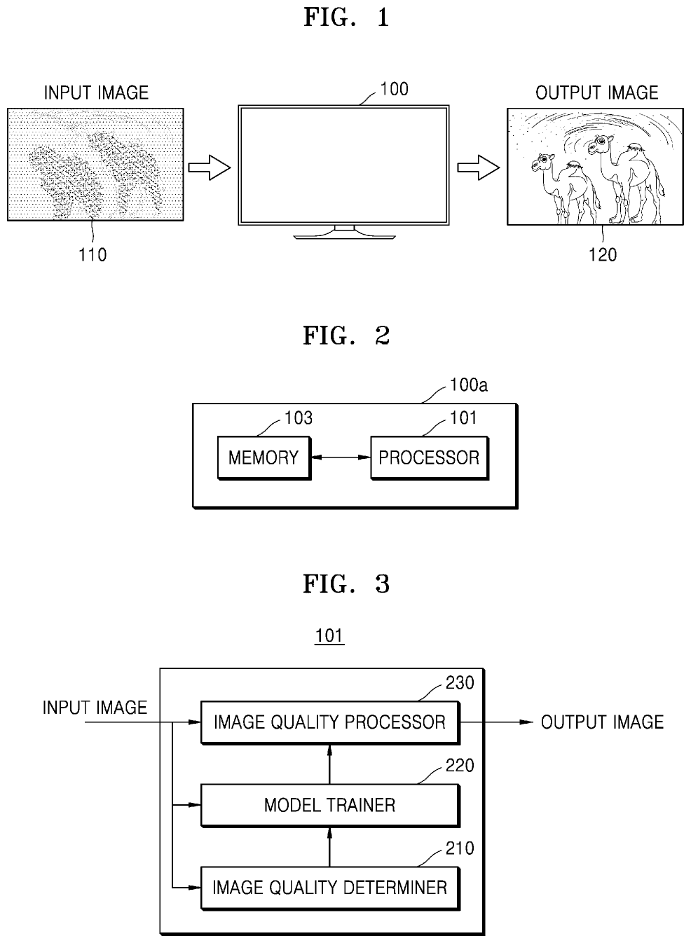

FIG. 2 is an internal block diagram of an image processing apparatus 100a according to some embodiments.

The image processing apparatus 100a of FIG. 2 may be an example of the image processing apparatus 100 of FIG. 1.

Referring to FIG. 2, the image processing apparatus 100a may include a processor 101 and a memory 103.

According to some embodiments, the memory 103 may store at least one instruction. In some embodiments, the memory 103 may store at least one program executed by the processor 101. At least one neural network and/or predefined operation rule or AI model may be stored in the memory 103. In some embodiments, the memory 103 may store data input to or output from the image processing apparatus 100a.

The memory 103 may include at least one type of storage medium, i.e., at least one of a flash memory-type memory, a hard disk-type memory, a multimedia card micro-type memory, a card-type memory (e.g., an SD card or an XD memory), random access memory (RAM), static RAM (SRAM), read-only memory (ROM), electrically erasable programmable ROM (EEPROM), PROM, a magnetic memory, a magnetic disc, or an optical disc.

In some embodiments, the memory 103 may include one or more instructions which, when executed by the processor 101, obtain the quality of an input image by analyzing the input image.

In some embodiments, the memory 103 may include one or more instructions which, when executed by the processor 101, obtain a meta model based on the quality of the input image.

In some embodiments, the memory 103 may include one or more instructions which, when executed by the processor 101, obtain a training data set using the input image.

In some embodiments, the memory 103 may include one or more instructions which, when executed by the processor 101, train the meta model with the training data set.

In some embodiments, the memory 103 may include one or more instructions which, when executed by the processor 101, perform image quality processing on the input image by using the trained meta model.

In some embodiments, the memory 103 may store a quality value of an input image fed at a first time point and quality values of past input images fed at past time points prior to the first time point.

In some embodiments, the memory 103 may store an average quality value for the input image at the first time point and an averaged quality value for the past input images fed at the past time points before the first time point.

In some embodiments, the meta model obtained and trained at the first time point may be stored in the memory 103.

In some embodiments, a meta model obtained and trained at a past time point before the first time point may be stored in the memory 103.

In some embodiments, the memory 103 may store a first time point exponential moving average model obtained by considering together the meta model obtained and trained at the first time point and the meta model trained at the past time point before the first time point. In other words, the first time point exponential moving average model may be obtained based on the meta model obtained and trained at the first time point and the metal model trained at the past time point.

In some embodiments, a plurality of reference models may be stored in the memory 103. The plurality of reference models may be image quality processing models pre-trained with training images having different quality values. In some embodiments, the memory 103 may store a quality value of training images used to train each of the plurality of reference models together with a corresponding reference model.

In some embodiments, training data for generating a training data set corresponding to an input image may be stored in the memory 103. The training data may include images in various categories. The image processing apparatus 100a may search for an image in the same category as the input image from among the training data and generate a training data set corresponding to the input image by using the found image.

In some embodiments, at least one neural network and/or predefined operating rule or AI model may be stored in the memory 103.

In some embodiments, a first neural network trained to assess the quality of an input image may be stored in the memory 103.

In some embodiments, a second neural network trained to classify a category of an input image may be stored in the memory 103.

In some embodiments, a third neural network trained to process the quality of an input image may be stored in the memory 103.

The image processing apparatus 100a may include one or more processors 101. The processor 101 may control all operations of the image processing apparatus 100a. The processor 101 may control the image processing apparatus 100a to function by accessing the memory 103 and executing one or more instructions stored in the memory 103.

In some embodiments, the one or more processors 101 may perform quality assessment on a video including a plurality of frames. To achieve this quality assessment, the processor 101 may obtain an image quality by performing quality assessment on each of the frames or each sub-region obtained by dividing each frame into a plurality of sub-regions.

In some embodiments, the one or more processors 101 may obtain a model-based quality score for each frame or each sub-region by using a first neural network. In some embodiments, the first neural network may be a neural network that receives an image as an input and is trained to assess the quality of the input image using the input image.

In some embodiments, the quality of an input image may include at least one of a compression quality, a blur quality, a resolution, or a noise for the input image.

In some embodiments, the one or more processors 101 may obtain a meta model based on the quality of an input image by executing one or more instructions.

In some embodiments, the one or more processors 101 may obtain a meta model using a plurality of reference models by executing one or more instructions. In some embodiments, each of the plurality of reference models may be an image quality processing model trained with training images having a different quality value.

In some embodiments, the reference models may include a first image quality processing model trained with images having a first quality value and a second image quality processing model trained with images having a second quality value. In some embodiments, the first quality value may be different from the second quality value.

In some embodiments, a reference model may be pre-trained with training images and stored in the memory 103, stored in an internal memory of the processor 101, or stored in a database (DB) external to the image processing apparatus 100a.

In some embodiments, training images used to train a reference model may be images having a quality value determined based on a distribution of quality values of training images.

In some embodiments, the one or more processors 101 may execute one or more instructions to search for one or more reference models from among a plurality of reference models by comparing each of quality values corresponding to the plurality of reference models with a quality value of an input image.

In some embodiments, based on a plurality of reference models being found, the one or more processors 101 may execute one or more instructions to obtain a meta model by interpolating the plurality of reference models.

In some embodiments, the one or more processor 101 may execute one or more instructions to obtain a meta model by interpolating parameters of a reference model.

In some embodiments, the one or more processors 101 may execute one or more instructions to obtain an averaged quality value for an input image at a first time point by considering together a quality value of the input image at the first time point and a quality value of a past input image at a past time point before the first time point, and obtain a meta model based on the averaged quality value. Obtaining a meta model based on the averaged quality value may mean searching for a reference model using the averaged quality value and, obtaining a meta model by using parameters of the found reference model.

In some embodiments, the one or more processors 101 may execute one or more instructions to obtain a training data set corresponding to an input image by using the input image.

In some embodiments, one or more processors 101 may execute one or more instructions to identify a category of the input image and obtain an image belonging to the identified category from training data. The training data may include images in various categories. The training data may be stored in the memory 103, stored in an internal memory of the processor 101, or stored in an external DB.

In some embodiments, the one or more processors 101 may execute one or more instructions to search for and obtain an image belonging to the identified category from among the training data.

In some embodiments, the one or more processors 101 may execute one or more instructions to obtain an image with degraded quality by processing the image belonging to the identified category to have a quality corresponding to the quality of the input image.

In some embodiments, the one or more processors 101 may execute one or more instructions to obtain an image with degraded quality by performing at least one of compression degradation, blurring degradation, resolution adjustment, or noise addition on the image belonging to the identified category. In some embodiments, the one or more processors 101 may execute one or more instructions to perform compression degradation on an image belonging to the identified category by encoding and decoding the image belonging to the identified category.

In some embodiments, the one or more processors 101 may execute one or more instructions to obtain a training data set including an image belonging to the identified category and an image with degraded quality.

In some embodiments, the one or more processors 101 may execute one or more instructions to train a meta model by using a training data set.

In some embodiments, the one or more processors 101 may execute one or more instructions to train a meta model by updating parameter values of the meta model to minimize a difference between an image belonging to the identified category and an image output from the meta model by inputting an image with degraded quality to the meta model.

In some embodiments, the one or more processors 101 may execute one or more instructions to obtain a meta model each time at least one of a frame, a scene including a plurality of frames, or a content type changes, and train the obtained meta model.

In some embodiments, the one or more processors 101 may execute one or more instructions to obtain a first time point exponential moving average model by considering together a meta model trained at the first time point and a meta model trained at a past time point before the first time point and obtain an output image by applying the first time point exponential moving average model to an input image.

In some embodiments, the one or more processors 101 may execute one or more instructions to obtain an output image from an input image by using a trained meta model or an exponential moving average model.

FIG. 3 is an internal block diagram of the processor 101 of FIG. 2, according to some embodiments.

Referring to FIG. 3, the processor 101 may include an image quality determiner 210, a model trainer 220, and an image quality processor 230.

In some embodiments, the image quality determiner 210 may determine an image quality or quality of an input image. The quality of an image may represent the degree of degradation in the image. After an image is obtained via a capture device, degradation occurs due to loss of information during processes such as processing, compression, storage, transmission, and restoration. The image quality determiner 210 may analyze an image to determine the degree of degradation in the image.

In some embodiments, the image quality determiner 210 may analyze the input image in real time to determine at least one of an image compression degradation, an image sharpness degree, a degree of blur, a degree of noise, or an image resolution.

In some embodiments, the image quality determiner 210 may assess the quality of the input image by using a first neural network trained to assess the quality of the input image. In some embodiments, the first neural network is a neural network trained to assess the quality of a video and/or an image by using an IQA technique and/or a VQA technique.

In some embodiments, the image quality determiner 210 may transmit, to the model trainer 220, the quality of the input image obtained by analyzing the input image.

In some embodiments, the image quality determiner 210 may stabilize the quality of an image by taking into account a case where the quality obtained for each image is not accurate or the quality of the image changes rapidly. In some embodiments, the image quality determiner 210 may stabilize the quality of an image via averaging of quality parameters calculated for each time/frame.

In some embodiments, the image quality determiner 210 may obtain an averaged quality value for an input image at a first time point by considering together a quality value of the input image at the first time point and a quality value of an input image at a past time point before the first time point.

In some embodiments, the image quality determiner 210 may use a method of obtaining a simple moving average for N past samples. In some embodiments, the image quality determiner 210 may determine, as a quality value of an input image fed at a current time point, an average of the sum of a quality value of a past image input at a past time point and the quality value of the input image fed at the current time point.

In some embodiments, the image quality determiner 210 may use an exponential moving average method for calculating an average of only values calculated in the past and a current input value. In some embodiments, the image quality determiner 210 may obtain a first time point exponential moving average quality value for an input image fed at the first time point by considering together a quality value of the input image obtained at the first time point and a past time point exponential moving average quality value obtained for an input image fed at a past time point before the first time point.

In some embodiments, the model trainer 220 may obtain a meta model by using an averaged quality value for an input image at the first time point, which is obtained by the image quality determiner 210, thereby preventing a rapid change in the quality of the input image.

In some embodiments, the model trainer 220 may receive the input image. The model trainer 220 may also receive the quality of the input image from the image quality determiner 210.

In some embodiments, the model trainer 220 may obtain a training data set corresponding to the input image by using the input image. To achieve this training data set, the model trainer 220 may obtain content characteristics of the input image. A category of the input image may vary according to content characteristics of the input video.

In some embodiments, the model trainer 220 may analyze the input image by using a second neural network trained to classify the input image into categories. The second neural network may analyze the input image to identify a category suitable for content characteristics of the input image as a probability value.

In some embodiments, the model trainer 220 may identify a category with a highest probability value as a category of the input image, and select an image belonging to the identified category from training data. The training data may be stored in the memory 103 or stored in an external database. In some embodiments, images stored as the training data may be high-quality images.

In some embodiments, the model trainer 220 may obtain a number of images from among images belonging to the same category as the input image. The number of images may be predetermined. In some embodiments, the model trainer 220 may identify, among categories of the input image, a number of categories having probability values in a descending order, and obtain images belonging to the identified categories in proportion to the probability values. The number of categories may be predetermined. For example, when the model trainer 220 determines that a probability that an object included in the input image is a dog is 70% and a probability that the object is a cat is 30%, the model trainer 220 may obtain images of dogs and images of cats from the training data in the ratio of 7:3.

In some embodiments, the model trainer 220 may degrade images belonging to the identified category to obtain images with degraded quality. In some embodiments, the model trainer 220 may degrade the quality of the images belonging to the identified category to correspond to the quality of the input image. For example, the model trainer 220 may perform compression degradation, blurring, or noise addition on the images belonging to the identified category. In some embodiments, the model trainer 220 may generate low-resolution (LR) images by down-sampling the images belonging to the identified category.

In some embodiments, the model trainer 220 may use, as a training data set, a high-quality image belonging to the identified category and an image with degraded quality obtained by performing image quality processing on the high-quality image.

In some embodiments, the model trainer 220 may obtain a meta model based on the quality of an input image. In some embodiments, the model trainer 220 may obtain a meta model by using a plurality of reference models. A reference model is an image quality processing model pre-trained using training images, and may be stored in the memory 103, an external DB, or the like.

In some embodiments, the model trainer 220 may search for a reference model trained with training images having a similar quality to the input image by comparing a quality value of images used to train each of the plurality of reference models with a quality value of the input image.

In some embodiments, when a plurality of reference models are found, the model trainer 220 may generate a meta model by interpolating the plurality of reference models. For example, the model trainer 220 may respectively assign weights to the plurality of found reference models and generate a meta model by performing a weighted sum operation on the reference models assigned the weights. A weight assigned to each reference model may be determined according to a difference between a quality value corresponding to a reference model and a quality value of the input image.

In some embodiments, the model trainer 220 may train a meta model by using a training data set corresponding to the input image. In some embodiments, the model trainer 220 may compare an image that is output from the meta model by inputting an image with degraded quality included in the training data set to the meta model with a non-degraded high quality image, which is included in the training data set, and adjust parameters of the meta model so that a difference between the two images is minimized. The meta model trained using the training data set corresponding to the input image may be referred to as a transfer model.

In some embodiments, the image quality processor 230 may load and use a meta model, i.e., a transfer model, obtained and trained by the model trainer 220. The quality processor 230 may process the quality of an input image by using the transfer model. In some embodiments, the image quality processor 230 may be a third neural network trained to process the quality of an input image. For example, the third neural network is an inference network that implements a super-resolution (SR) algorithm capable of converting a LR image into a high-resolution (HR) image. The image quality processor 230 may obtain a HR image by processing the quality of the input image using SR technology using deep learning.

In some embodiments, the image processing apparatus 100a may be an electronic apparatus in which AI is combined with an edge device that outputs an image. In some embodiments, the image processing apparatus 100a may process the quality of an image by using on-device AI technology.

In some embodiments, the model trainer 220 included in the processor 101 may operate as an on-device AI operating unit. In this case, the on-device AI operating unit may generate a meta model by collecting information on its own using a quality value of an input image evaluated by the image quality determiner 210. In other words, the on-device AI operating unit may obtain a meta model to be applied to the input image by using the quality value of the input image, and generate a transfer model suitable for the input image by training the meta model with training data corresponding to the input image.

In some embodiments, the image quality determiner 210 and the model trainer 220 included in the processor 101 may both operate as the on-device AI operating unit. In this case, the on-device AI operating unit may assess the quality of the input image and update the meta model by using a quality value of the input image obtained via the assessment.

The image quality processor 230 may load the transfer model generated by the on-device AI operating unit and apply the transfer model to the input image to perform image quality processing thereon.

In some embodiments, the on-device AI operating unit included in the image processing apparatus 100a may be activated or deactivated. In some embodiments, whether the on-device AI operating unit is activated may depend on model specifications, capacity, or performance of the image processing apparatus 100a. For example, when the image processing apparatus 100a has a built-in large-capacity memory and a high-performance central processing unit (CPU), the image processing apparatus 100a may activate the on-device AI operating unit and perform image quality processing using a meta model updated to be suitable for the input image. In some embodiments, when the user determines whether to activate the on-device AI operating unit in a settings menu on the image processing apparatus 100a by using a user interface or the like, the image processing apparatus 100a may determine whether to activate the on-device operating unit while performing image quality processing according to the user's selection.

In some embodiments, the image processing apparatus 100a may obtain a meta model corresponding to an input image by using the on-device AI operating unit in response to activation of the on-device AI operating unit, and train the obtained meta model with training data suitable for the input image to thereby obtain an output image from the input image by using a transfer model adaptive to the input image.

In some embodiments, the image processing apparatus 100a may not obtain a meta model in response to deactivation of the on-device AI operating unit. The image processing apparatus 100a may perform image quality processing on an input image by using a reference model selected arbitrarily from among reference models or a reference model selected by default.

In some embodiments, the image processing apparatus 100a may obtain a meta model in response to deactivation of the on-device AI operating unit but perform image quality processing by applying the meta model directly to an input image while omitting a process of training the meta model with training data corresponding to the input image.

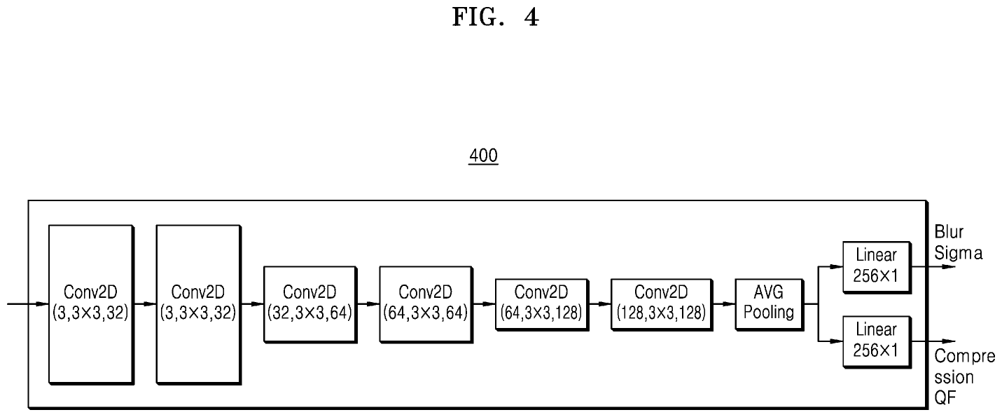

FIG. 4 is a diagram for describing a neural network used to determine the quality of an input image, according to some embodiments.

In some embodiments, the image processing apparatus 100a may determine the quality of an input image by using a first neural network 400. For example, the first neural network 400 shown in FIG. 4 may be included in the image quality determiner 210 of FIG. 3.

In some embodiments, the first neural network 400 may be a neural network trained to assess the quality of an input image based on the input image. In some embodiments, the first neural network 400 may be a classifier for determining a quality parameter.

In some embodiments, the first neural network 400 may be a convolutional neural network (CNN), a deep CNN (DCNN), or a CapsNet-based neural network.

In some embodiments, the first neural network 400 may receive various pieces of data and be trained to discover or learn on its own a method of analyzing the pieces of input data, a method of classifying the pieces of input data, and/or a method of extracting, from the pieces of input data, features necessary for generating resulting data from the pieces of input data. The first neural network 400 may be made into an AI model with desired characteristics by applying a learning algorithm to a large amount of training data. Such training may be performed by the image processing apparatus 100a itself, or through a separate server/system. In this case, a learning algorithm is a method of training a target device (e.g., a robot) using a large amount of training data so that the target device may make decisions or predictions on its own.

Examples of learning algorithms may include supervised learning, unsupervised learning, semi-supervised learning, and reinforcement learning, and the learning algorithms according to embodiments of the disclosure are not limited to the above-described examples except where otherwise clearly indicated.

For example, the first neural network 400 may be trained as a data inference model via supervised learning using training data as an input value. In some embodiments, the first neural network 400 may be trained as a data inference model via unsupervised learning that discovers a criterion for determining the quality of an image by learning on its own the type of data necessary for determining the quality of the image without any special guidance. In some embodiments, the first neural network 400 may be trained as a data inference model via reinforcement learning exploiting feedback regarding whether a result of inferring the quality of an image based on training is correct.

In some embodiments, the first neural network 400 may include an input layer, a hidden layer, and an output layer. In some embodiments, the hidden layer may include a plurality of hidden layers. The first neural network 400 may be a deep neural network (DNN) including two or more hidden layers. A DNN is a neural network that performs computations through a plurality of layers, and a depth of the network may increase as the number of internal layers that perform the computations increases. DNN computations may include CNN computations and the like.

In some embodiments, the first neural network 400 may be trained using a training DB including each training image and quality values corresponding to each training image as a training data set. For example, a manufacturer may generate a degraded image by compressing, blurring, and/or adding noise to a HR image in various ways and use a quality value of the degraded image and the HR image as a training data set to train the first neural network 400. That is, the first neural network 400 may be trained so that when a degraded image is input to the first neural network 400, a result output from the first neural network 400 is a quality value of the degraded image.

In some embodiments, an image including red (R), green (G), and blue (B) channels (RGB 3ch) may be input to the first neural network 400 shown in FIG. 4. According to some embodiments, the image processing apparatus 100a may determine the R, G, and B channels (RGB 3ch) included in the input image as an input image to be input to the first neural network 400. In some embodiments, the image processing apparatus 100a may convert R, G, and B channels (RGB 3ch) included in the input image to Y, U, and V channels (YUV 3ch) via color space conversion. The Y channel is a channel representing a luminance signal, the U channel is a channel representing a difference between the luminance signal and a blue component, and the V channel is a channel representing a difference between the luminance signal and a red component. The image processing apparatus 100a may determine the Y, U, and V channels (YUV 3ch) as an input image to be input to the first neural network 400.

In some embodiments, the first neural network 400 may receive R, G, and B channels (RGB 3ch) or Y, U, and V channels (YUV 3ch) and extract a feature map by performing a convolution operation by applying one or more kernels or filters to the input image. For example, the first neural network 400 may output 32 channels by applying 32 3×3 filters to an input image. As a kernel scans input data to be subjected to the convolution operation from left to right and from top to bottom one pixel at a time, the first neural network 400 may generate a result value by multiplying the input data by weight values included in the kernel and adding together the products. Although data to be subjected to the convolution operation may be scanned while moving one pixel at a time, the data may be scanned while moving two or more pixels at a time. The number of pixels by which the input data moves during the scan process is referred to as a stride, and a size of an output feature map may be determined according to a size of the stride.

In some embodiments, a size of data for the input image fed into the first neural network 400 may be reduced as the input image passes through convolutional layers. Referring to FIG. 4, convolutional layers included in the first neural network 400 may be represented by boxes of a certain size. Here, a size of each box may represent a size of an image. That is, as shown in FIG. 4, a leftmost box included in the first neural network 400 has a size corresponding to the size of the input image. The size of the input image fed into the first neural network 400 may be reduced by half after passing through the left two layers. Subsequently, after passing through two more layers, the size of an image may be reduced by half again. To reduce a size of the extracted feature map, the first neural network 400 may perform subsampling (pooling) by using methods such as max pooling, average pooling, L2-norm pooling, etc., but the pooling methods are not limited thereto.

In some embodiments, the first neural network 400 may have a single-input multiple-output structure in which two types of quality values are output with respect to a single input image.

In some embodiments, in order to reduce network complexity, the first neural network 400 may have a structure in which middle layers for feature extraction are commonly used, and an output is separated at a final stage to output quality factors (QFs) of the image.

In some embodiments, the first neural network 400 may obtain a 128-channel vector through pooling and convert it into a 256-channel vector via a linear network. After that, the first neural network 400 may obtain a final result by reducing the 256-channel vector to one dimension (1D). In some embodiments, the first neural network 400 may output defined two quality values as a quality value of the input image.

In some embodiments, the first neural network 400 may obtain a blur sigma (or kernel sigma) and a compression quality (compression QF) as a result. Kernel Sigma and QF may implicitly represent degradations that may occur until a compressed image is reproduced. However, this is merely an embodiment, and in some embodiments, the first neural network 400 may obtain various types of quality values of an image as a result.

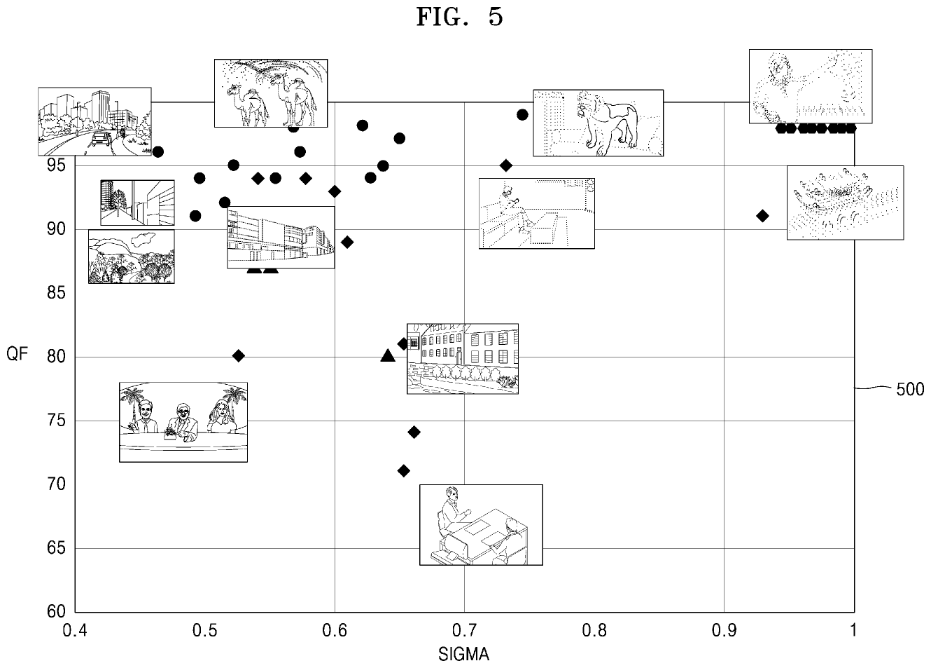

FIG. 5 is a graph illustrating the quality of an input image according to some embodiments.

In some embodiments, the image processing apparatus 100a may obtain the quality of an input image by analyzing the input image. The image quality determiner 210 included in the image processing apparatus 100a may analyze quality values of an input image in real time by using a quality analyzer such as the first neural network 400 shown in FIG. 4.

FIG. 5 is a graph 500 representing a result of analyzing the quality of input images on a quality plane, i.e., a two-dimensional (2D) graph illustrating the result of analyzing the quality of captured videos via an image quality analyzer.

Referring to FIG. 5, a horizontal axis on the graph 500 represents a kernel sigma value, and a vertical axis represents a compression quality (QF) of an image. The kernel sigma value is a value representing a blur quality of an image, and the larger the kernel sigma value, the greater the degree of blur. The QF indicates the degree of degradation due to compression, and the lower the QF value, the more severe the degradation due to compression, and the higher the QF value, the less the degradation due to compression. In the graph 500, different geometric shapes represent quality values of images having different resolutions. As seen in the graph 500, various quality values may be distributed even for an image having the same resolution. This distributed aspect is because an image having the same resolution may have various qualities according to degradations during acquisition, transmission, and/or storage of the image.

However, this is merely an example, and in some embodiments, the image processing apparatus 100a may further obtain another quality factor in addition to kernel sigma and QF of each input image by analyzing a corresponding input image. For example, the image processing apparatus 100a may analyze an input image to further obtain a quality factor representing the degree of noise included in the input image. In this case, a quality value of each input image obtained by the image processing apparatus 100a may be represented as a three-dimensional (3D) graph representing kernel sigma, QF, and noise level on three axes.

In some embodiments, the image processing apparatus 100a may generate a meta model adaptive to a quality value of each input image based on quality values of input images.

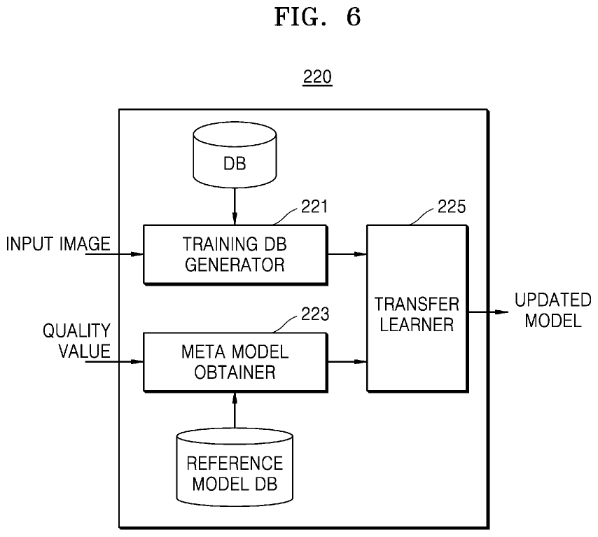

FIG. 6 is a diagram for describing the model trainer 220 of FIG. 3 according to some embodiments.

Referring to FIG. 6, the model trainer 220 may include a training DB generator 221, a meta model obtainer 223, and a transfer learner 225.

In some embodiments, the model trainer 220 may obtain a meta model based on the quality of an input image, and generate a transfer model adaptive to the input image by training the meta model by using a training data set corresponding to the input image.

In some embodiments, the training DB generator 221 may obtain a training data set corresponding to an input image by using the input image. To achieve this training data set, the training DB generator 221 may identify a category of the input image. For example, the training DB generator 221 may analyze the input image to identify a category of the input image as a probability value. The training DB generator 221 may identify a category with a highest probability value as a category of the input image, and select an image belonging to the identified category from training data stored in a DB. The training data may include high-quality images. The training data may be stored in an external DB or stored in the internal memory 103.

In some embodiments, the training DB generator 221 may obtain a predetermined number of images from among images belonging to the same category as the input image. In some embodiments, the training DB generator 221 may identify, among categories of the input image, a predetermined number of categories having probability values in a descending order, and obtain images belonging to the identified categories in proportion to the probability values. For example, when the training DB generator 221 determines that a probability that an object included in the input image is a dog is 70% and a probability that the object is a cat is 30%, the training DB generator 221 may respectively obtain images of dogs and images of cats from the training data in the ratio of 7:3.

In some embodiments, the training DB generator 221 may degrade images belonging to the identified category to obtain images with degraded quality. In some embodiments, the training DB generator 221 may process the quality of the images belonging to the identified category to correspond to the quality of the input image. For example, the training DB generator 221 may generate an image with degraded quality by performing at least one of compression degradation, blurring, noise addition, or down-sampling on the images belonging to the identified category.

In some embodiments, the training DB generator 221 may use, as a training data set, an image belonging to the identified category and an image with degraded quality obtained by performing image quality processing on the image.

In some embodiments, the training DB generator 221 may transmit the training data set to the transfer learner 225.

In some embodiments, the meta model obtainer 223 may obtain a meta model based on the quality of an input image, i.e., a quality value thereof. When on-device learning is performed with a random initial model without the meta model obtainer 223, a long training time is required. However, according to some embodiments, through the meta model obtainer 223, a model suitable for the quality of the input image may be selected in real time, and a meta model may be quickly generated using the selected model.

In some embodiments, the meta model obtainer 223 may obtain a meta model by using a plurality of reference models. A reference model is an image quality processing model pre-trained using training images, and may be stored in the memory 103, a reference model DB, or the like. The manufacturer may generate a plurality of reference models in advance and store them in the image processing apparatus 100a.

The plurality of reference models may be image quality processing models trained using training images having different qualities. For example, when the plurality of reference models include a first reference model and a second reference model, the first reference model may be an image quality processing model trained with training images having a first quality value, and the second reference model may be an image quality processing model trained with training images having a second quality value.

In some embodiments, the plurality of reference models may be each trained with training images having uniformly spaced quality values. In some embodiments, in some embodiments, a quality value corresponding to a reference model may be determined based on a distribution of quality values of training images. For example, the manufacturer may obtain quality values of training images by analyzing the training images, and determine a representative quality sampling position based on a statistical distribution of the quality values of the training images. The manufacturer may train a reference model by using images having a quality value corresponding to a representative quality sampling position as training data.

In some embodiments, the meta model obtainer 223 may search for a reference model trained with training images having a similar quality to the input image by comparing a quality value of images used to train each of the plurality of reference models with the quality value of the input image.

In some embodiments, the meta model obtainer 223 may search for a predetermined number of reference models, each of which is trained with images having a quality value with a small difference from the quality value of the input image, from among the plurality of reference models. For example, the meta model obtainer 223 may search for a reference model among the plurality of reference models, the reference model being trained with images having a quality value with a difference from the quality value of the input image with a level of within a reference value.

In some embodiments, when one reference model is found, the meta model obtainer 223 may obtain the found reference model as a meta model.

In some embodiments, when a plurality of reference models are found, the meta model obtainer 223 may obtain a meta model by interpolating the plurality of found reference models. In some embodiments, the meta model obtainer 223 may respectively assign weights to the plurality of found reference models and obtain a meta model by performing a weighted sum operation on the reference models assigned the weights. Here, a weight assigned to a reference model may be determined according to a difference between a quality value corresponding to the reference model and a quality value of the input image. For example, the larger a difference between a quality value corresponding to a reference model and a quality value of the input image, the smaller a weight assigned to the reference model, and the smaller the difference between the quality value corresponding to the reference model and the quality value of the input image, the larger the weight assigned to the reference model.

In some embodiments, the meta model obtainer 223 may stabilize a meta model by taking into account a case where a rapid change in image quality occurs when different meta models are applied to each image. In some embodiments, the meta model obtainer 223 may obtain a first time point exponential moving average model by considering together a meta model trained at a first time point and a meta model trained at a past time point before the first time point. In this case, the quality processor 230 applies the first time point exponential moving average model to an input image fed at the first time point, instead of applying a transfer model obtained at the first time point, so that a quality-processed output image may not show a sharp difference in quality from a previous image.

In some embodiments, the meta model obtainer 223 may transmit the obtained meta model to the transfer learner 225.

In some embodiments, the transfer learner 225 may train the meta model obtained by the meta model obtainer 223 by using a training data set received from the training DB generator 221.

In some embodiments, the transfer learner 225 may train the meta model by using a gradient descent algorithm. Gradient descent is a first-order optimization algorithm for finding an approximate value and is a method for finding a value of x when a value of a function is a minimum value by calculating a slope (gradient) of the function and continuously moving the slope in a direction that reduces an absolute value of the gradient.

In some embodiments, the transfer learner 225 may compare an image that is output from the meta model by inputting an image with degraded quality included in a training data set to the meta model with an image belonging to an identified category included in the training data set, calculate a difference between the two images as a slope of a function, and obtain parameters of a model when an absolute value of the slope reaches a minimum. That is, the transfer learner 225 may obtain a transfer model by training the meta model by continuously updating parameters of the meta model so that a quantitative difference between the image output from the meta model and a high-quality image included in the training data set is minimized.

In some embodiments, the transfer learner 225 may train the meta model by using various known learning algorithms. The transfer learner 225 may selectively apply learning hyperparameters (a learning rate, a batch size, a termination condition, etc.) and optimization algorithms (stochastic gradient descent (SGD), Adam, AdamP, etc.) according to system constraints, e.g., limited memory, operators, power, etc.

In some embodiments, the meta model obtainer 223 and the transfer learner 225 may each generate a transfer model periodically or at random intervals. In some embodiments, the meta model obtainer 223 may obtain a new meta model in units of a frame, in units of a scene including a plurality of frames, or each time a content type changes, e.g., when the content type changes from news to drama. In some embodiments, the transfer learner 225 may update the transfer model by training the meta model each time the meta model obtainer 223 obtains a new meta model. For example, the transfer learner 225 may generate a new transfer model by training a meta model in units of a frame, in units of a scene including a plurality of frames, or each time a content type of a video changes.

In this way, according to some embodiments, the transfer learner 225 may generate a transfer model adaptively trained according to the input image. A meta model updated by the transfer learner 225 may be loaded into the image quality processor 230 and used for image quality processing.

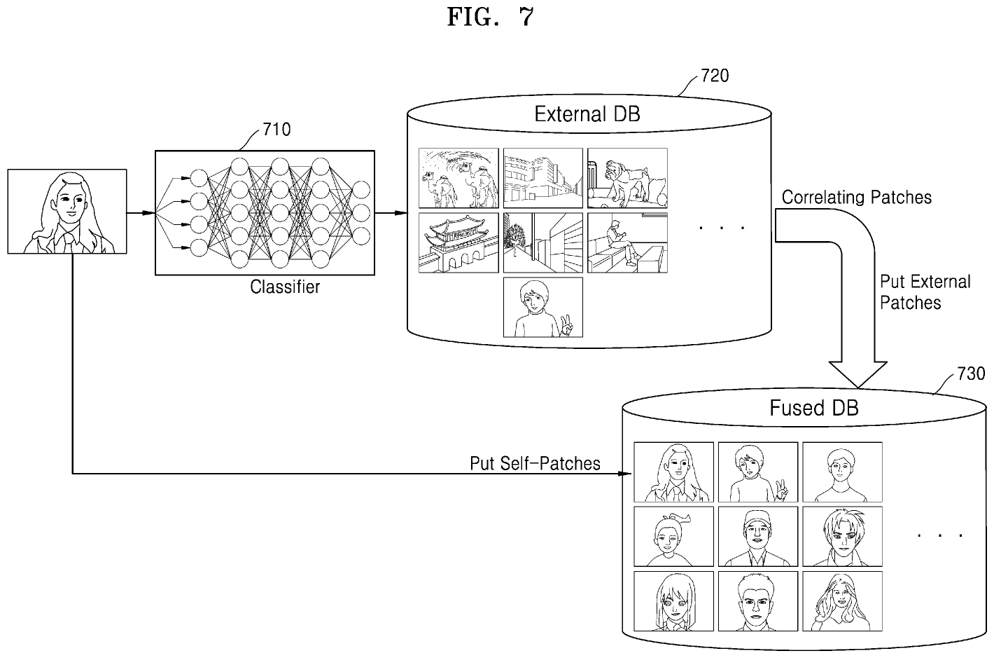

FIG. 7 is a diagram for describing an example in which the training DB generator 221 of FIG. 6 obtains an image in a similar category to an input image, according to some embodiments.

Referring to FIG. 7, the training DB generator 221 may selectively collect images having content characteristics similar to the characteristics of an input image from an external DB 720 to create a training DB having content characteristics similar to those of the input image.

In some embodiments, the image processing apparatus 100a may be an electronic apparatus in which AI is combined with an edge device that outputs an image. In some embodiments, the image processing apparatus 100a may process the quality of an image by using on-device AI technology. In this case, because the image processing apparatus 100a does not use a cloud server with infinite resources, it is necessary to utilize a finite amount of resources more efficiently.

In some embodiments, the training DB generator 221 included in the image processing apparatus 100a may select only images having content characteristics similar to content characteristics of an input image from the external DB 720, and use the images to train and use a model so that the quality of the input image may be processed more efficiently and accurately.

In some embodiments, the training DB generator 221 may identify a category to which the input image belongs.

In some embodiments, the training DB generator 221 may identify a category of the input image by using a second neural network 710. In some embodiments, the second neural network 710 may be an algorithm or a set of algorithms for receiving an image and classifying an image into categories based on the received image, software for executing the set of algorithms, and/or hardware for executing the set of algorithms.

In some embodiments, the second neural network 710 may use a Softmax Regression function to obtain various classes or categories as a result. The softmax function may be used when there are multiple ground truth labels (classes) for classification, i.e., when predicting multiple classes. When the total number of classes is k, the softmax function may receive a k-dimensional vector and estimate a probability for each class. In some embodiments, the second neural network 710 may be a neural network that receives the k-dimensional vector and is trained so that a probability for each class obtained from the k-dimensional vector equals the ground truth. However, the second neural network 710 is not limited thereto, and may be implemented as various types of algorithms capable of classifying an input image into categories.

In some embodiments, the second neural network 710 may obtain a probability value for a category or class of an input image as a result. For example, the second neural network 710 may obtain, as a result value, a vector respectively representing a probability that a category of the input image is a human face, a probability that it is a dog, a probability that it is a cat, and the probability that it is a building as 0.5, 0.2, 0.2, and 0.1.

In some embodiments, the training DB generator 221 may identify a category with a highest probability value as a category of the input image. For example, in the above example, the training DB generator 221 may identify a category of the input image as being a human face that is a category having a largest value in a vector.

In some embodiments, the training DB generator 221 may obtain images having content characteristics similar to content characteristics of the input image, i.e., images included in the same category as or a similar category to the input image. In some embodiments, the training DB generator 221 may obtain images included in a similar category to the input image from the external DB 720. However, the training DB generator 221 is not limited thereto, and in some embodiments may obtain images included in a similar category to the input image from among training images stored in the memory 103 other than the external DB 720.

In some embodiments, images having various types of categories may be each labeled with an index or tag for a category of each image and stored in the external DB 720 or the memory 103.

Referring to FIG. 7, the training DB generator 221 may obtain, from the external DB 720, one or a plurality of images identified by an index of a similar category to the input image, and create a new DB 730 including the obtained one or plurality of images.

In some embodiments, the training DB generator 221 may identify only a category having a highest probability value among categories of the input image, and obtain images belonging to the identified category. For example, in the above example, the training DB generator 221 may obtain only images of a human face having a highest probability value from the external DB 720.

In some embodiments, the training DB generator 221 may identify only a predetermined number of categories having probability values in a descending order among categories of the input image, and obtain images belonging to the identified categories in proportion to the probability values. For example, in the above example, the training DB generator 221 may identify only three categories having probability values in a descending order. For example, the training DB generator 221 may identify a human face, a dog, and a cat as categories of the input image, and respectively obtain images of a human face, images of a dog, and images of a cat from the external DB 720 in the ratio of 5:2:2.

In some embodiments, the training DB generator 221 may also include the input image in the new DB 730.

In some embodiments, it is assumed in FIG. 7 that the training DB generator 221 identifies a human face, which is a category with a highest probability value, as being a category of the input image. The training DB generator 221 may obtain N various human face images from the external DB 720 and create a new DB 730 including the N various human face images. The N human face images may be different images.

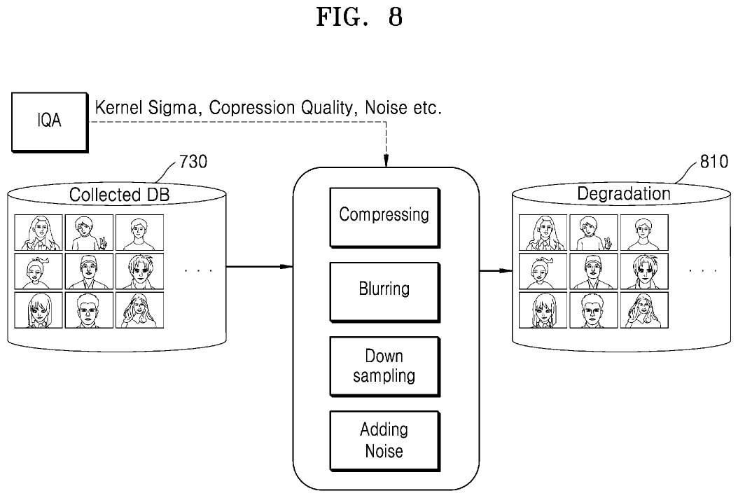

FIG. 8 is a diagram for describing an example in which the training DB generator 221 of FIG. 6 performs image quality processing on an image in a similar category to an input image, according to some embodiments.

Referring to FIG. 8, the training DB generator 221 may degrade the quality of images included in the new DB 730.

In some embodiments, the training DB generator 221 may degrade images included in the new DB 730 according to quality characteristics of an input image.

In some embodiments, the training DB generator 221 may receive a degradation factor and a quality value of an image using IQA, e.g., from the quality determiner 210, and degrade the collected images to have a quality value corresponding to the quality value of the image.

For example, when the image quality determiner 210 analyzes an image to obtain a quality value of the image using kernel sigma representing the degree of blur of the image and a QF representing the degree of compression degradation of the image, the training DB generator 221 may degrade images included in the new DB 730 by using blur and image compression method in the same way.

In some embodiments, the training DB generator 221 may perform filtering to degrade an image. For example, the training DB generator 221 may use a 2D kernel to apply blur degradation to an image. In some embodiments, the training DB generator 221 may process a box blur to model motion degradation. In some embodiments, the training DB generator 221 may use a box-shaped filter or a Gaussian filter to apply optical blur to an image.

In some embodiments, the training DB generator 221 may adjust filter coefficients according to blur defined by the image quality determiner 210. For example, in a case where the image quality determiner 210 predicts a standard deviation (or Std) of a Gaussian kernel, a Gaussian filter having the same Std may also be used as the kernel to degrade an image.

Degradation may be performed via generally known spatial filtering and may be the same operation as that of a low-pass filter in the field of signal processing. In detail, degradation may be performed via a convolution operation with a 2D Gaussian kernel. Here, a coefficient value in the kernel may be changed according to a value determined by the image quality determiner 210.

In some embodiments, the training DB generator 221 may use, as a training data set, images included in the new DB 730 and degraded images 810 generated by performing quality degradation on the images.

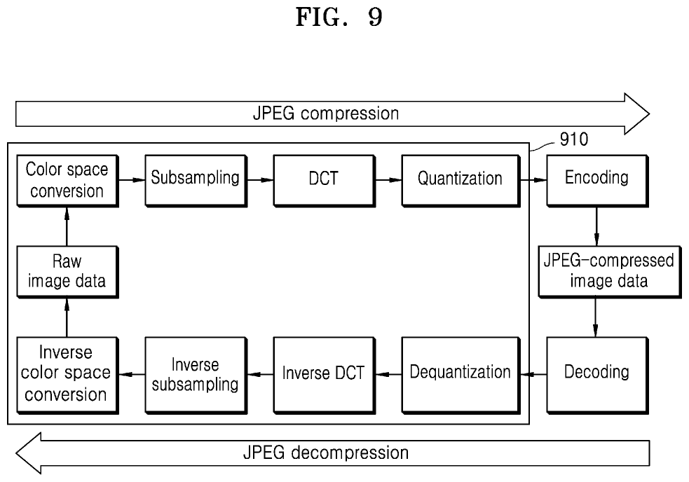

FIG. 9 is a diagram for describing a method of applying degradation occurring during a compression process to a training image, according to some embodiments.

Multimedia data including videos and the like requires a wide bandwidth for transmission due to their massive volume. For example, an uncompressed video with a resolution of 4K or higher requires a high bandwidth to the extent that mid- and long-range transmission is impossible. A 4K 60FPS uncompressed video with a resolution of 3840×2160 pixels that is the standard resolution for ultra high-definition (UHD) broadcasting requires a very high bandwidth of 11,384 billion bits per second (Bbps). In order to transmit such a huge amount of data, encoding an image using a compression coding technique is an essential process. Images may be compressed in various compression formats. For example, images may be compressed in various compression formats such as Joint Photographic Experts Group (JPEG), Moving Picture Experts Group 2 (MPEG2), H.264, high efficiency video coding (HEVC), etc. During a compression process, information in an image may be lost, and thus a distortion may occur in the image.

Encoded image data is generated in a format defined by each video codec and transmitted to a decoding device, and the decoding device decodes an image sequence to output image data. A compressed image may be degraded again due to loss of information when the compressed image is reconstructed in the decoding process.

In some embodiments, the training DB generator 221 may generate a compression-degraded image by applying, to a training image, a degradation occurring in a compression process among various types of degradations.

In some embodiments, the training DB generator 221 may generate compression-degraded images by respectively performing compression degradation on images included in the new DB 730. To do so, the training DB generator 221 may generate compression-degraded images by encoding/decoding the images included in the new DB 730. For example, the training DB generator 221 may degrade a still image by using a JPEG compression method for the still image. The training DB generator 221 may perform compression degradation on a video by using a compression method such as MPEG2, H.264, or HEVC for the video.

FIG. 9 illustrates the sequence of JPEG encoding and decoding processes for an image. Referring to FIG. 9, raw image data may be encoded into a JPEG compressed image sequentially through color conversion, frequency conversion (discrete cosine transform (DCT)), quantization, and arithmetic coding. The encoded image may be reconstructed through decoding, dequantization, inverse DCT, and inverse color conversion.

In some embodiments, the training DB generator 221 may obtain a compression-degraded image by performing JPEG encoding and decoding on an image to be degraded in the order illustrated in FIG. 9.

Because entropy coding performed in the encoding/decoding processes is a lossless compression method, quality degradation does not occur during entropy encoding and entropy decoding. Accordingly, in some embodiments, the training DB generator 221 may obtain a compression-degraded image by performing only the methods indicated by reference numeral 910 on the image to be degraded while omitting the entropy coding and entropy decoding therefor.

In some embodiments, the training DB generator 221 may place an image to be degraded on a position of raw image data, perform color conversion, frequency conversion (DCT), and quantization on the image to be degraded, and perform dequantization, inverse DCT, and inverse color conversion on the quantized image, thereby obtaining a compression-degraded image.

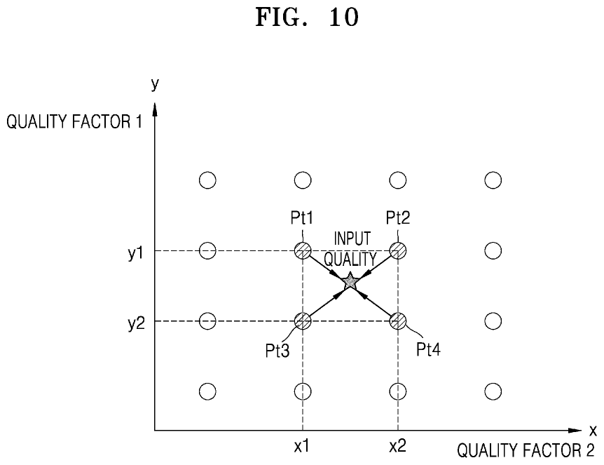

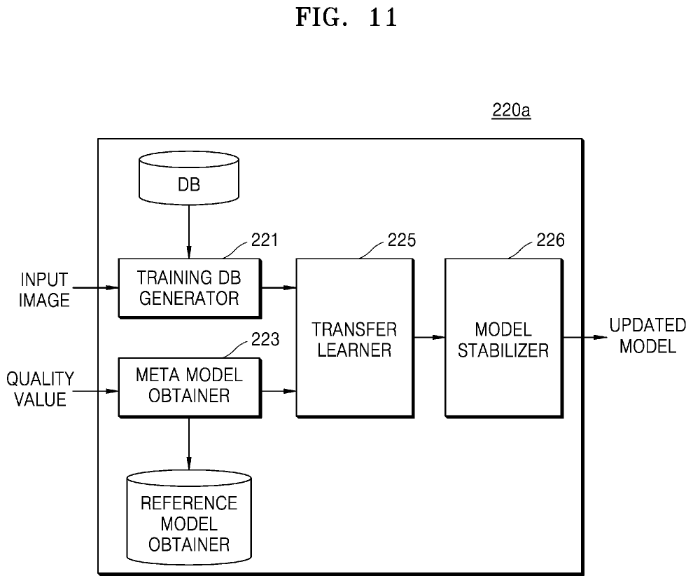

FIG. 10 is a diagram for describing an example in which a meta model is obtained using reference models, according to some embodiments.

In some embodiments, an on-device learning system included in the image processing apparatus 100a may generate a meta model suitable for image quality processing in real time from a pre-trained model and perform transfer learning using the meta model in order to speed up learning. For this purpose, reference models may be prepared in advance. In some embodiments, a reference model may be a pre-trained image quality processing model used by the on-device learning system to generate a meta model.

In some embodiments, the quality determiner 210 included in the image processing apparatus 100a may analyze the quality of an input image in real time by using a quality analyzer to thereby obtain a quality value of the input image. Quality values of the input image may be represented on a quality plane graph shown in FIG. 5 or 10.

In some embodiments, a manufacturer of the image processing apparatus 100a may generate a reference model in advance, train the reference model, and include the trained reference model in the on-device learning system of the image processing apparatus 100a.

In some embodiments, the manufacturer may obtain a quality value of each training image by analyzing the quality of training images. The manufacturer may obtain a quality plane graph as shown in FIG. 10. Like the quality plane graph of FIG. 5, the quality plane graph of FIG. 10 is a graph representing the quality of an image using two quality factors, where a horizontal axis represents quality factor 1 and a vertical axis represents quality factor 2.

In some embodiments, the manufacturer may take N points in a grid form on the quality plane graph of FIG. 10. In some embodiments, training images corresponding to the N points may be training images degraded to have a corresponding quality. In other words, in the graph of FIG. 10, each point may represent training images having a quality value corresponding to coordinate values of the point. For example, a first point pt1 may represent training images having coordinate values (x1, y1) of the first point pt1 as a quality value, and a second point pt2 may represent training images having coordinate values (x2, y1) of the second point pt2 as a quality value.

In some embodiments, the manufacturer may generate training images corresponding to the N points by degrading non-degraded training images. The manufacturer may generate a reference model by training an image quality processing model by using the non-degraded training images and the training images generated by degrading them. For example, the manufacturer may generate a first reference model corresponding to the first point pt1 by training a quality processing model by using, as a training data set, non-degraded training images and training images obtained by degrading the non-degraded training images to have a quality value of the first point pt1. In some embodiments, the first reference model may be an image quality processing model trained to restore the non-degraded training images from images corresponding to the quality of the training images. Similarly, the second reference model may be an image quality processing model trained to restore non-degraded training images from images corresponding to the quality of training images corresponding to the second point pt2 (ok?).

In some embodiments, the manufacturer may generate N reference models respectively corresponding to the N points in a grid form shown in FIG. 10. The manufacturer may determine a quality position of target training images as being a position of each of the N points in a grid form via uniform sampling, so that the N reference models may be trained with training images having uniformly spaced quality values.

However, the disclosure is not limited thereto, and in some embodiments, the manufacturer may determine a quality value corresponding to a reference model based on a distribution of quality values of training images. For example, the manufacturer may obtain quality values of training images by analyzing the training images, and determine a representative quality sampling position based on a statistical distribution of the quality values of the training images. For example, the manufacturer may determine a representative sampling position by using a K-means clustering algorithm. This method is an algorithm for finding a point with a minimum error when a data distribution is represented by K representative points.

The manufacturer may group a quality value distribution of training images into a certain number of clusters, i.e., K clusters, and determine a quality value that minimizes a variance of a distance difference in each cluster. The manufacturer may train a reference model by using, as a training data set, images having the determined quality value and their corresponding non-degraded training images. In this case, because the reference model may be trained using images having a high statistical quality value as training images, the number of reference models may be reduced. In addition, the reference model obtained in this way may be more likely to be used later when generating a meta model. When the meta model is generated using the reference model obtained in this way, computational complexity and memory usage may be reduced.

In some embodiments, the manufacturer may train the reference model offline via a cloud system for a high-performance computer. In other words, a reference model generation process is not included in the on-device learning system. The manufacturer may store models trained offline in the memory 103 of the image processing apparatus 100a.

In some embodiments, the image processing apparatus 100a may obtain a meta model by loading a pre-trained and stored reference model during on-device learning. In detail, the meta model obtainer 223 included in the image processing apparatus 100a may obtain a meta model in real time by using a pre-trained reference model.

In some embodiments, the meta model obtainer 223 may obtain a meta model suitable for a quality value of an input image. For this purpose, the meta model obtainer 223 may search for a reference model trained with training images having a quality value similar to that of the input image by using the quality value of the input image determined by the image quality determiner 210.

In some embodiments, the meta model obtainer 223 may search for one or more reference models from among a plurality of reference models by comparing each of quality values respectively corresponding to the plurality of reference models with the quality value of the input image.

In some embodiments, the meta model obtainer 223 may select only a reference model that is closest in terms of distance. For example, the meta model obtainer 223 may search for a reference model trained with training images having a quality value closest to the quality value of the input image. For example, the meta model obtainer 223 may search for the reference model trained with training images having a quality value within a threshold range of the quality value of the input image. The meta model obtainer 223 may calculate, as a distance, a difference between a quality value of the training images used to train reference models and a quality value of a currently input image, and search for close reference models in ascending order of distances.

In some embodiments, the meta model obtainer 223 may search for a reference model among the plurality of reference models, the reference model being trained with training images having a quality value with a difference t from the quality value of the input image with a level of within the reference value. In some embodiments, from among the plurality of reference models, the meta model obtainer 223 may search for reference models trained with a predetermined number of training images in the order in which the difference from the quality value of the input image is close.

For example, it is assumed in FIG. 10 that an input image has a quality value of a point where an star-shaped figure is located. In some embodiments, the meta model obtainer 223 may search for a reference model corresponding to a point close to the star-shaped figure on the quality plane graph shown in FIG. 10, i.e., a reference model trained with training images having a quality value close to the quality value of the input image.

The meta model obtainer 223 may search for the first through fourth reference models respectively corresponding to the first point pt1, the second point pt2, a third point pt3, and a fourth point pt4 close to the star-shaped figure. Referring to FIG. 10, a reference model searched for by the meta model obtainer 223 using the quality value of the input image is represented as a hatched point.

In some embodiments, the meta model obtainer 223 may generate a meta model by interpolating a plurality of found reference models. In some embodiments, interpolating a plurality of reference models may mean interpolating parameters of known reference models and using them as parameters of a meta model. Because the meta model obtainer 223 knows the quality value of the input image, the meta model obtainer 223 may obtain a weight by using a distance between the quality value of the input image and a quality value of a reference model, i.e., a position of the star-shaped figure in FIG. 10 and a position of the reference model.

In some embodiments, the meta model obtainer 223 may interpolate reference models in the same way as in Equation 1 below.

Meta model=W1*reference model 1+W2*reference model 2+ . . . +WN*reference model N. [Equation 1]

Here, W1 to WN are weights respectively corresponding to reference model 1 to reference model N, and the sum of weights W1 to WN is 1.

Reference model 1 to reference model N may mean parameters of reference model 1 to reference model N. A weight may be determined in inverse proportion to a distance between a quality value corresponding to a selected reference model and input quality.

However, the disclosure is not limited thereto, and the meta model obtainer 223 may use various methods to obtain a meta model by interpolating a plurality of reference models. For example, the meta model obtainer 223 may obtain a meta model from a reference model by using various interpolation methods, such as linear interpolation, spline interpolation, cubic interpolation, bilinear interpolation that is an extension of the linear interpolation to 2D, bicubic interpolation that is an extension of the cubic interpolation to 2D, etc.

FIG. 11 is a diagram for describing an example of the model trainer 220 of FIG. 3 according to some embodiments.

A model trainer 220a of FIG. 11 may be an example of the model trainer 220 of FIG. 3. Therefore, descriptions already provided with respect to FIG. 6 will be omitted for conciseness.

Referring to FIG. 11, the model trainer 220a may include the training DB generator 221, the meta model obtainer 223, the transfer learner 225, and a model stabilizer 226. That is, unlike the model trainer 220 of FIG. 6, the model trainer 220a of FIG. 11 may further include the model stabilizer 226.

In a general linear system, outputs may be predicted based on inputs, but in a deep learning model, it is impossible to accurately predict outputs according to learning conditions and initial values. Therefore, it may be difficult to prevent a flickering phenomenon caused by a rapid change in image quality only by averaging the quality of an image via the image quality determiner 210. In particular, when image-based learning methods are applied to a video, flickering may occur due to a difference in quality between successive images, which is caused by a variation in performance of a transfer model that performs image quality restoration. Because an on-device learning system performs training each time an input environment changes, a stable update to a model is a very important factor in stabilizing the on-device learning system.

In some embodiments, to address a problem due to a sharp change in quality between images included in a video the image processing apparatus 100a may adjust a variation in performance of a transfer model for each frame by using the model stabilizer 226.

In some embodiments, the model stabilizer 226 may stabilize transfer models by using a moving average method for the transfer models. In some embodiments, the model stabilizer 226 may stabilize transfer models by using a method of averaging parameters of the transfer models. In some embodiments, the model stabilizer 226 may average the transfer models by using a simple moving average method or an exponential moving average method.

In some embodiments, the model stabilizer 226 may distinguish between a meta model obtained and trained based on an input image and an application model that applies the meta model to an actual input image, and obtain an application model to be applied to an input image fed at a current time point by using a meta model obtained and trained at the current time point and a meta model obtained and trained at a past time point.

For example, the model stabilizer 226 may obtain a simple moving average of a meta model generated for a currently input image and meta models generated for images input in the past, and obtain the result as an application model to be applied to the currently input image. In some embodiments, the model stabilizer 226 may obtain an application model to be applied to a current image input at a first time point by averaging a meta model obtained and trained at the first time point and meta models obtained and trained at past time points before the first time point.

In some embodiments, the model stabilizer 226 may obtain an application model to be applied to a current input image by using an exponential moving average method for averaging meta models obtained in the past and a meta model obtained for the current input image.

In some embodiments, the model stabilizer 226 may obtain a t-th time point exponential moving average model by considering together a meta model obtained and trained at the first time point (time point t) and a meta model applied to a past input image fed at a past time point before time point t. The t-th time point exponential moving average model may refer to a meta model that is actually applied to an input image fed at time point t and performs image quality processing on the input image.

For example, the model stabilizer 226 may obtain a t-th time point exponential moving average model by using Equation 2 below.

t-th time point exponential moving average model=α*(model trained at time point t)+(1−a)*(t−1-th time point exponential moving average model) [Equation 2]

Here, alpha (α) may be determined according to the rate of convergence or stability of the on-device learning system. The models of Equation 2 are a set of parameter values of the meta model, and the parameter values of the meta model may include values of filter weights and biases.

Equation 2 may be rearranged as follows:

t-th time point exponential moving average model=model used at time point t-1+α*δ

where δ=(model trained at time point t)−(t−1-th time point exponential moving average model).

This may mean a method of updating a meta model by gradually adding delta model δ as much as a to a past model. In this case, because the number of multiplication operators for model update is reduced by half, power consumption may be reduced.

The value of a may be used as a fixed value according to various conditions, and may be newly initialized or changed due to a change of scene, a change in content, etc.

In some embodiments, the image quality processor 230 may obtain an output image by applying the t-th time point exponential moving average model obtained by the model stabilizer 226 to an input image fed at time point t. That is, in some embodiments, the model stabilizer 226 may process the quality of the input image by applying a t-th time point exponential moving average model to an input image fed at time point t instead of applying a meta model obtained and trained at time point t to the input image, thereby performing quality stabilization so that an output image obtained by performing image quality processing on the input image does not show a drastic difference in quality from images output at previous time points.

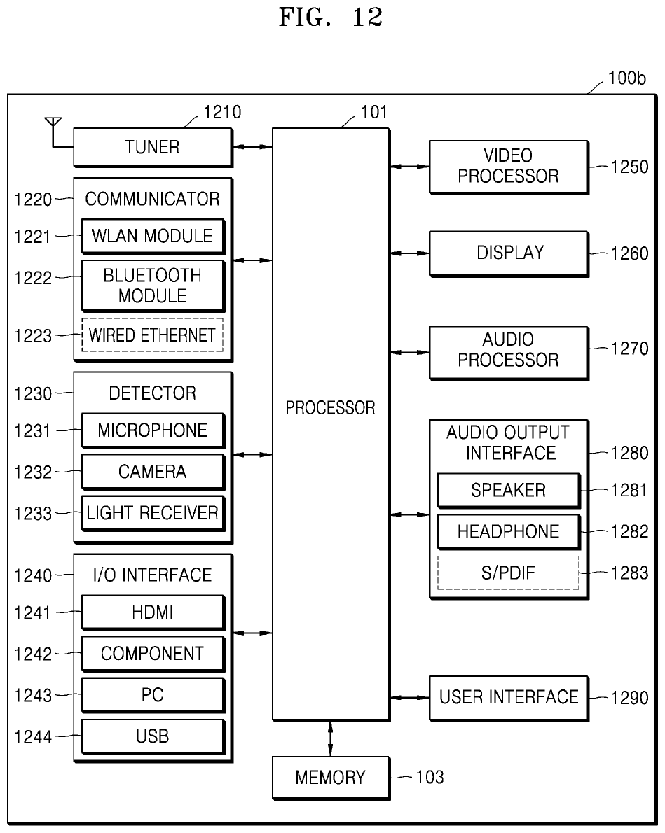

FIG. 12 is an internal block diagram of an image processing apparatus 100b according to some embodiments.

The image processing apparatus 100b of FIG. 12 is an example of the image processing apparatus 100a of FIG. 2, and may include components of the image processing apparatus 100a of FIG. 2.

Referring to FIG. 12, the image processing apparatus 100b may include, in addition to the processor 101 and the memory 103, a tuner 1210, a communicator 1220, a detector 1230, an input/output (I/O) interface 1240, a video processor 1250, a display 1260, an audio processor 1270, an audio output interface 1280, and a user interface 1290.

By performing amplification, mixing, resonance, etc. of broadcast content or the like received in a wired or wireless manner, the tuner 1210 may tune and then select only a frequency of a channel that the image processing apparatus 100b desires to receive from among many radio wave components. The content received via the tuner 1210 undergoes decoding to be separated into audio, video and/or additional information. The audio, video, and/or additional information may be stored in the memory 103 according to control by the processor 101.

The communicator 1220 may connect the image processing apparatus 100b to an external device or server according to control by the processor 101. Through the communicator 1220, the image processing apparatus 100b may download a program or an application needed by the image processing apparatus 100b from the external device or server, or perform web browsing. Also, the communicator 1220 may receive content from an external device or obtain training data from an external DB.

The communicator 1220 may include at least one of a wireless local area network (WLAN) module 1221, a Bluetooth module 1222, a UWB module 1223, or a wired Ethernet 1224 corresponding to the performance and structure of the image processing apparatus 100b. The communicator 1220 may also receive a control signal via a control device (not shown) such as a remote control or the like according to control by the processor 101. The control signal may be implemented in the form of a Bluetooth signal, a radio frequency (RF) signal, or a Wi-Fi signal. The communicator 1220 may further include, in addition to the Bluetooth module 1222, other short-range communication modules such as a near field communication (NFC) module (not shown), a Bluetooth Low Energy (BLE) module, etc. The communicator 1220 may exchange connection signals with an external device, etc. via short-range communication such as Bluetooth or BLE.

The detector 1230 detects a user's voice, images, or interactions and may include a microphone 1231, a camera 1232, and a light receiver 1233. The microphone 1231 may receive a voice uttered by the user, convert the received voice into an electrical signal, and output the electrical signal to the processor 101. The camera 1232 may include a sensor (not shown) and a lens (not shown) and capture an image formed on a screen. The light receiver 1233 may receive an optical signal (including a control signal). The light receiver 1233 may receive an optical signal corresponding to a user input (e.g., touching, pressing, touch gesture, voice, or motion) from a control device (not shown) such as a remote control, a mobile phone, or the like. A control signal may be extracted from the received optical signal according to control by the processor 101.

The I/O interface 1240 may receive, according to control by the processor 101, from a device outside the image processing apparatus 100b, a video (e.g., a moving image signal, a still image signal, etc.), audio (e.g., a voice signal, a music signal, etc.), and additional information such as metadata, etc. The metadata may include high dynamic range (HDR) information about content, a description of the content, a content title, a content storage location, etc. The I/O interface 1240 may include one of a high-definition multimedia interface (HDMI) port 1241, a component jack 1242, a PC port 1243, and a universal serial bus (USB) port 1244. The I/O interface 1240 may include a combination of the HDMI port 1241, the component jack 1242, the PC port 1243, and the USB port 1244.

The video processor 1250 may process image data to be displayed by the display 1260 and perform various image processing operations, such as decoding, rendering, scaling, noise filtering, frame rate conversion, resolution conversion, etc., on the image data.

In some embodiments, the video processor 1250 may improve the quality of a video and/or a frame by using a trained meta model.

The display 1260 may display, on a screen, content received from a broadcasting station, an external server, an external storage medium, or the like. The content may include, as a media signal, a video signal, an audio signal, a text signal, etc. Also, the display 1260 may display, on the screen, a video signal or an image received through the HDMI port 1241.

In some embodiments, when the video processor 1250 improves the quality of the video or frame, the display 1260 may output the video or frame with the improved quality.

When the display 1260 is formed as a touch screen, the display 1260 may be used as an input device as well as an output device. Furthermore, the image processing apparatus 100b may include two or more displays 1260 according to its implemented configuration.

The audio processor 1270 processes audio data. The audio processor 760 may perform various types of processing, such as decoding, amplification, noise filtering, etc., on the audio data.

The audio output interface 1280 may output, according to control by the processor 101, audio contained in content received via the tuner 1210, audio input via the communicator 1220 or the I/O interface 1240, and audio stored in the memory 103. The audio output interface 1280 may include at least one of a speaker 1271, a headphone output terminal 1272, or a Sony/Phillips Digital Interface (S/PDIF) output terminal 1273.

The user interface 1290 may receive a user input for controlling the image processing apparatus 100b. The user interface 1290 may include, but is not limited to, various types of input devices consisting of a touch panel for sensing a user's touch, a button for receiving a user's push manipulation, a wheel for receiving a user's rotation manipulation, a keyboard, a dome switch, a microphone for speech recognition, a motion detection sensor for sensing a motion, etc. In addition, when the image processing apparatus 100b is manipulated by a remote controller (not shown), the user interface 1290 may receive a control signal received from the remote controller.

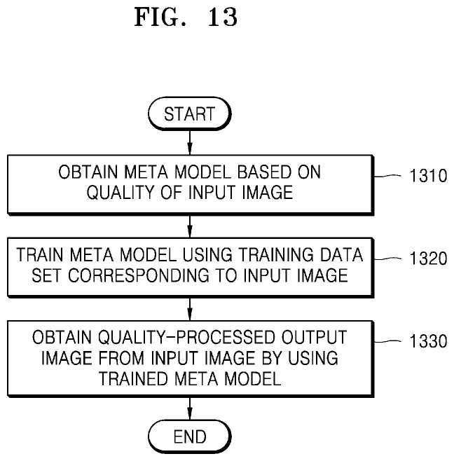

FIG. 13 is a flowchart of a method of performing image quality processing on an input image, according to some embodiments.

Referring to FIG. 13, an image processing apparatus may obtain a meta model based on the quality of an input image (operation 1310).

In some embodiments, the image processing apparatus may obtain a quality value of an input image and compare the quality value of the input image with quality values corresponding to pre-trained reference models to thereby search for a reference model having a quality value corresponding to the quality of the input image. In some embodiments, the image processing apparatus may obtain a meta model by using the found reference model.

In some embodiments, the image processing apparatus may train the meta model by using a training data set corresponding to the input image (operation 1320).

In some embodiments, the image processing apparatus may obtain a training data set corresponding to the input image. The image processing apparatus may obtain an image having similar content characteristics to the content characteristics of the input image by using content characteristics of the input image, and may use the obtained images as training data. The image processing apparatus may degrade the quality of the image having the similar content characteristics and train the meta model by using an non-degraded image having the similar content characteristics and an image with degraded quality as a training data set.

In some embodiments, the image processing apparatus may obtain a quality-processed output image from the input image by using the trained meta model (operation 1330).

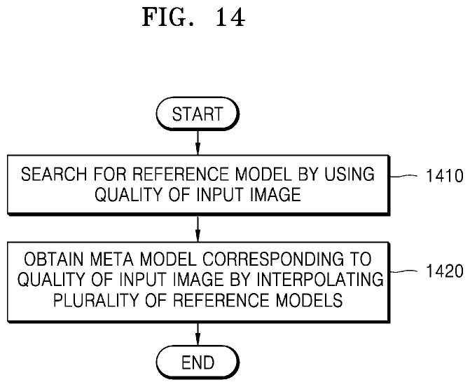

FIG. 14 is a flowchart of a process of obtaining a meta model based on the quality of an input image, according to some embodiments.

Referring to FIG. 14, the image processing apparatus may search for a reference model by using the quality of an input image (operation 1410).

In some embodiments, the image processing apparatus may search for a plurality of reference models that have been pre-trained and stored therein. The plurality of reference models may be image quality processing models that have been trained with training images having different quality values.

In some embodiments, the image processing apparatus may search for one or more reference models among a plurality of reference models by comparing a quality value of the input image with each of quality values respectively corresponding to the plurality of reference models, and selecting one or more reference models having quality values corresponding to the quality value of the input image. For example, the image processing apparatus may search for a reference model among the plurality of reference models, the reference model being trained with training images having a quality value with a difference from the quality value of the input image with a level of within the reference value.

In some embodiments, the image processing apparatus may obtain a meta model corresponding to the quality of the input image by interpolating a plurality of found reference models (operation 1420).

For example, the image processing apparatus may obtain a weighted sum of parameter values of a plurality of reference models and generate a meta model having the weighed sum of parameter values. The image processing apparatus may obtain a weight to be applied to each reference model by using a distance between a quality value of the input image and a quality value corresponding to a reference model. In this case, the sum of weight values respectively applied to the reference models becomes 1.

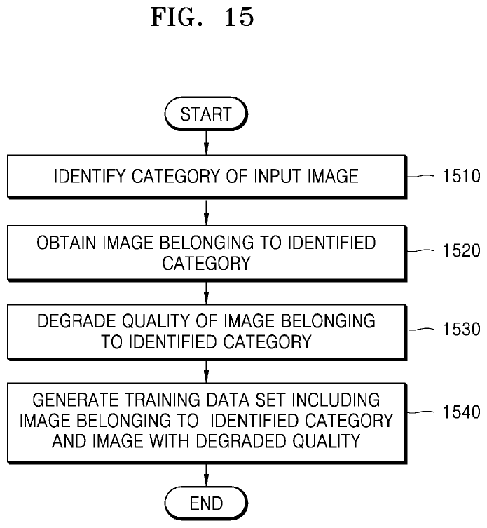

FIG. 15 is a flowchart of a process of obtaining a training data set corresponding to an input image, according to some embodiments.

Referring to FIG. 15, the image processing apparatus may identify a category of an input image (operation 1510). The image processing apparatus may classify the input image using content characteristics of the input image. The image processing apparatus may identify a category suitable for the content characteristics of the input image.

In some embodiments, the image processing apparatus may obtain images belonging to the identified category (operation 1520). In some embodiments, the image processing apparatus may obtain images belonging to the identified category from among training images stored in an external DB, a memory, or the like.

In some embodiments, the image processing apparatus may degrade the quality of the images belonging to the identified category (operation 1530). In some embodiments, the image processing apparatus may obtain images with degraded quality by performing at least one of compression degradation, blurring degradation, resolution adjustment, or noise addition on the images belonging to the identified category. In some embodiments, the image processing apparatus may perform compression degradation on an image belonging to the identified category by encoding and decoding the image belonging to the identified category.

In some embodiments, the image processing apparatus may generate a training data set including an image belonging to the identified category and an image obtained by degrading the quality of the image (operation 1540).

In some embodiments, the image processing apparatus may generate a transfer model adaptive to the input image by training a meta model by using a training data set.

An image processing apparatus and operation method thereof according to some embodiments may be implemented in the form of recording media including instructions executable by a computer, such as a program module executed by the computer. The computer-readable recording media may be any available media that are accessible by the computer, and include both volatile and non-volatile media and both removable and non-removable media. Furthermore, the computer-readable recording media may include computer storage media and communication media. The computer storage media include both volatile and non-volatile and both removable and non-removable media implemented in any method or technology for storage of information, such as computer-readable instructions, data structures, program modules, or other data. The communication media typically embody computer-readable instructions, data structures, program modules, other data in a modulated data signal such as a carrier wave, or other transmission mechanism, and include any information transmission media.

In addition, the image processing apparatus and operation method thereof according to some embodiments may be implemented as a computer program product including a computer-readable recording medium having recorded thereon a program for realizing obtaining a meta model based on the quality of an input image, training the meta model by using a training data set corresponding to the input image, and obtaining, based on the trained meta model, a quality-processed output image from the input image.

The computer-readable storage medium may be provided in the form of a non-transitory storage medium. In this regard, the term ‘non-transitory storage medium’ only means that the storage medium is a tangible device and does not include a signal, and the term does not differentiate between where data is semi-permanently stored in the storage medium and where the data is temporarily stored in the storage medium. For example, the ‘non-transitory storage medium’ may include a buffer in which data is temporarily stored.

According to some embodiments, methods may be included in a computer program product when provided. The computer program product may be traded, as a product, between a seller and a buyer. For example, the computer program product may be distributed in the form of a computer-readable storage medium (e.g., compact disc ROM (CD-ROM)) or distributed on-line (e.g., downloaded or uploaded) via an application store or directly between two user devices (e.g., smartphones). For online distribution, at least a part of the computer program product (e.g., a downloadable app) may be at least transiently stored or temporarily created on a computer-readable storage medium such as a server of a manufacturer, a server of an application store, or a memory of a relay server.

The above description is provided for illustration, and it will be understood by one of ordinary skill in the art that changes in form and details may be readily made therein without departing from technical idea or essential features of the disclosure. Accordingly, the above-described embodiments of the disclosure and all aspects thereof are merely examples and are not limiting. For example, each component defined as an integrated component may be implemented in a distributed fashion, and likewise, components defined as separate components may be implemented in an integrated form.

1. An image processing apparatus comprising:
a memory storing one or more instructions; and
one or more processors configured to access the memory and execute the one or more instructions stored in the memory to:
obtain a meta model based on a quality of an input image,
train the meta model by using a training data set corresponding to the input image, and
obtain a quality-processed output image from the input image, based on the trained meta model.

2. The image processing apparatus of claim 1, wherein the one or more processors are further configured to execute the one or more instructions to:
obtain an averaged quality value for the input image obtained at a first time point based on both a quality value of the input image at the first time point and a quality value of an input image obtained at a past time point before the first time point, and
obtain the meta model corresponding to the averaged quality value.

3. The image processing apparatus of claim 1, wherein the one or more processors are further configured to execute the one or more instructions to obtain the meta model by using a plurality of reference models, and
the plurality of reference models are each an image quality processing model that has been pre-trained with training images having a different quality value.

4. The image processing apparatus of claim 3, wherein the different quality value is based on a distribution of quality values of training images in the training data set.

5. The image processing apparatus of claim 3, wherein the one or more processors are further configured to execute the one or more instructions to search for one or more reference models among the plurality of reference models by comparing each of the quality values corresponding to the plurality of reference models with a quality value of the input image to find one or more reference models that have a quality value within a threshold range of the quality value of the input image, and obtain the meta model by using the found one or more reference models.

6. The image processing apparatus of claim 5, wherein the found one or more reference models comprises a plurality of found reference models,
wherein the one or more processors are further configured to execute the one or more instructions to assign weights respectively to the plurality of found reference models and obtain the meta model by performing a weighted sum operation on the plurality of found reference models assigned with the weights,
wherein each of the weights is determined according to a difference between a quality value corresponding to a reference model and the quality value of the input image.

7. The image processing apparatus of claim 1, wherein the one or more processors are further configured to execute the one or more instructions to obtain the quality of the input image, and
wherein the quality of the input image comprises at least one of a compression quality, a blur quality, a resolution, or noise for the input image.

8. The image processing apparatus of claim 1, wherein the one or more processors are further configured to execute the one or more instructions to:
identify a category of the input image,
obtain an image belonging to the category,
obtain an image with a degraded quality by processing the image belonging to the category to have a quality corresponding to the quality of the input image, and
obtain the training data set including the image belonging to the category and the image with the degraded quality.

9. The image processing apparatus of claim 8, wherein the one or more processors are further configured to execute the one or more instructions to train the meta model so that a difference between the image belonging to the category and an image that is output from the meta model by inputting the image with the degraded quality to the meta model is minimized.

10. The image processing apparatus of claim 8, wherein the one or more processors are further configured to execute the one or more instructions to obtain the image with the degraded quality by performing at least one of compression degradation, blurring degradation, resolution adjustment, or noise addition on the image belonging to the category.

11. The image processing apparatus of claim 10, wherein the one or more processors are further configured to execute the one or more instructions to perform compression degradation on the image belonging to the identified category by encoding and decoding the image belonging to the category.

12. The image processing apparatus of claim 1, wherein the one or more processors are further configured to execute the one or more instructions to obtain the meta model and train the obtained meta model each time at least one of a frame, a scene including a plurality of frames, or a content type changes.

13. The image processing apparatus of claim 1, wherein the one or more processors are further configured to execute the one or more instructions to:
obtain a first time point exponential moving average model based on both a meta model trained at a first time point and a meta model trained at a past time point before the first time point, and
input the input image to the first time point exponential moving average model and obtain the quality-processed output image as on output from the first time point exponential moving average model.

14. An image processing method performed by an image processing apparatus, the image processing method comprising:
obtaining a meta model based on a quality of an input image;
training the meta model by using a training data set corresponding to the input image; and
obtaining a quality-processed output image from the input image, based on the trained meta model.

15. The image processing method of claim 14, wherein obtaining of the meta model comprises:
obtaining an averaged quality value for the input image obtained at a first time point based on both a quality value of the input image at the first time point and a quality value of an input image obtained at a past time point before the first time point; and
obtaining the meta model corresponding to the averaged quality value.

16. The image processing method of claim 14, wherein obtaining of the meta model comprises:
for each of a plurality of reference models, determining a weight according to a difference between a quality value corresponding to the reference model and the quality value of the input image;
assigning the determined weights respectively to the plurality of reference models; and
obtaining the meta model by performing a weighted sum operation on the plurality of reference models according to the assigned weights.

17. The image processing method of claim 14, further comprising obtaining the training data set corresponding to the input image by:
identifying a category of the input image;
obtaining an image belonging to the category;
obtaining an image with a degraded quality by processing the image belonging to the category to have a quality corresponding to the quality of the input image; and
obtaining the training data set including the image belonging to the category and the image with the degraded quality.

18. The image processing method of claim 17, wherein the training of the meta model comprises training the meta model so that a difference between the image belonging to the category and an image that is output from the meta model by inputting the image with the degraded quality to the meta model is minimized.

19. The image processing method of claim 14, wherein the obtaining of the quality-processed output image comprises:
obtaining a first time point exponential moving average model based on both a meta model trained at a first time point and a meta model trained at a past time point before the first time point; and
inputting the input image into the first time point exponential moving average model and obtaining the quality-processed output image as on output from the first time point exponential moving average model.

20. A computer-readable recording medium having recorded thereon a program which, when executed by one or more processors, causes the one or more processors to at least:
obtain a meta model based on a quality of an input image;
train the meta model by using a training data set corresponding to the input image; and
obtain a quality-processed output image from the input image based on the trained meta model.
